(19) United States
(12) Patent Application Publication
(10) Pub. No.: US 2024/0284508 A1
(43) Pub. Date: Aug. 22, 2024

(54) PREEMPTION TO SUPPORT LOW-LATENCY (LL) DATA

(71) Applicant: NEWRACOM, Inc., Irvine, CA (US)

(72) Inventors: Joonsoo LEE, Seoul (KR); Si-Chan NOH, Seoul (KR)

(73) Assignee: NEWRACOM, Inc., Irvine, CA (US)

(21) Appl. No.: 18/583,475

(22) Filed: Feb. 21, 2024

Related U.S. Application Data
(60) Provisional application No. 63/487,222, filed on Feb. 27, 2023.
(60) Provisional application No. 63/486,435, filed on Feb. 22, 2023.

(51) Int. Cl. H04W 74/0816; H04L 1/00; H04L 5/00

(52) U.S. Cl. CPC H04W 74/0816; H04L 1/0007; H04L 5/0053

(57) ABSTRACT

Disclosed herein is a method performed by an access point (AP) in a wireless network to transmit low latency data. The method includes wirelessly receiving a data frame from a first station (STA) during a transmission opportunity (TXOP) of the first STA, responsive to determining that the AP has low latency data to transmit, wirelessly transmitting a block acknowledgement (BA) frame that acknowledges the data frame to the first STA, wherein the BA frame includes an indication that the AP has low latency data to transmit so the first STA should hold its transmission, and wirelessly transmitting a low latency data frame to a second STA following the transmission of the BA frame.

### CROSS-REFERENCE TO RELATED APPLICATION

This application claims the benefit of U.S. Provisional Application No. 63/487,222, filed Feb. 27, 2023, titled, “Preemption to Support Low-latency (LL) data”; and U.S. Provisional Application No. 63/486,435, filed Feb. 22, 2023, titled, “Preemption to Support Low-Latency (LL) data”, which are hereby incorporated by reference.

### TECHNICAL FIELD

The present disclosure generally relates to wireless communications, and more specifically, relates to the use of preemption to support the transmission of low-latency data in a wireless network.

### BACKGROUND

Institute of Electrical and Electronics Engineers (IEEE) 802.11 is a set of physical and Media Access Control (MAC) specifications for implementing Wireless Local Area Network (WLAN) communications. These specifications provide the basis for wireless network products using the Wi-Fi brand managed and defined by the Wi-Fi Alliance. The specifications define the use of the 2.400-2.500 Gigahertz (GHz) as well as the 4.915-5.825 GHz bands. These spectrum bands are commonly referred to as the 2.4 GHz and 5 GHz bands. Each spectrum is subdivided into channels with a center frequency and bandwidth. The 2.4 GHz band is divided into 14 channels spaced 5 Megahertz (MHz) apart, though some countries regulate the availability of these channels. The 5 GHz band is more heavily regulated than the 2.4 GHz band and the spacing of channels varies across the spectrum with a minimum of a 5 MHz spacing dependent on the regulations of the respective country or territory.

WLAN devices are currently being deployed in diverse environments. These environments are characterized by the existence of many Access Points (APs) and non-AP stations (STAs) in geographically limited areas. Increased interference from neighboring devices gives rise to performance degradation. Additionally, WLAN devices are increasingly required to support a variety of applications such as video, cloud access, and offloading. Video traffic, in particular, is expected to be the dominant type of traffic in WLAN deployments. With the real-time requirements of some of these applications, WLAN users demand improved performance.

Support for low latency (LL) data is one of the main requirements in future wireless networks. For example, the scope of the standard for beyond IEEE 802.11be includes low latency traffic delivery for real-time services (e.g., virtual reality (VR), augmented reality (AR), and mixed reality (MR)). In conventional wireless networks, if a station (STA) has a transmission opportunity (TXOP) and transmits data, the other devices cannot initiate their transmission to guarantee the safe transmission of the TXOP holder's data. Such an operation scenario prevents low latency transmission.

Conventional WLANs allow stations to occupy channels or links for a relatively long period of time (e.g., by granting a TXOP to a STA) to avoid having to compete for channel access with other STAs. However, this feature of conventional WLANs makes it difficult for low latency applications or stations to obtain channel access opportunities, which makes it difficult to satisfy strict latency requirements.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example wireless local area network (WLAN) with a basic service set (BSS) that includes a plurality of wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates Inter-Frame Space (IFS) relationships, in accordance with some embodiments of the present disclosure.

FIG. 5 illustrates a Carrier Sense Multiple Access/Collision Avoidance (CSMA/CA) based frame transmission procedure, in accordance with some embodiments of the present disclosure.

FIG. 6 shows a table comparing various iterations of Institute of Electrical and Electronics Engineers (IEEE) 802.11 standard, in accordance with some embodiments of the present disclosure.

FIG. 7 shows a table, which describes fields of an Extreme High Throughput (EHT) frame format, in accordance with some embodiments of the present disclosure.

FIG. 8 is a diagram showing a scenario where an AP has low latency data to transmit to STAn−1 during STA1's uplink TXOP, according to some embodiments.

FIG. 9 is a diagram showing how the AP can preempt STA1's TXOP to transmit low latency data, according to some embodiments.

FIG. 10 is a diagram showing an interpretation of bits B20-B23 of the U-SIG field, according to some embodiments.

FIG. 11 is a diagram showing a block ACK frame format, according to some embodiments.

FIG. 12 is a diagram showing a BA control field format, according to some embodiments.

FIG. 13 is a diagram showing STA1's TXOP being extended to compensate for STA1's TXOP being preempted, according to some embodiments.

FIG. 14 is a diagram showing STA1 extending its TXOP using a CTS to self frame, according to some embodiments.

FIG. 15 is a diagram showing a scenario where STAn has low latency data to transmit to the AP during STA1's uplink TXOP, according to some embodiments.

FIG. 16 is a diagram showing how STAn can preempt STA1's TXOP to transmit low latency data, according to some embodiments.

FIG. 17 is a diagram showing pseudocode for determining whether a STA is allowed to transmit during an (OFDMA) random access uplink transmission, according to some embodiments.

FIG. 18 is a diagram showing STA1's TXOP being extended to compensate for STA1's TXOP being preempted, according to some embodiments.

FIG. 19 is a diagram showing a scenario where a STAs have low latency data to transmit to the AP during the AP's downlink TXOP, according to some embodiments.

FIG. 20 is a diagram showing how STAn can preempt the AP's TXOP to transmit low latency data, according to some embodiments.

FIG. 21 is a diagram showing AP's TXOP being extended to compensate for AP's TXOP being preempted, according to some embodiments.

FIG. 22 is a flow diagram showing a method performed by an AP for transmitting low latency data during a TXOP of a first STA, according to some embodiments.

FIG. 23 is a flow diagram showing a method performed by a first STA for allowing an AP to transmit low latency data, according to some embodiments.

FIG. 24 is a flow diagram showing a method performed by a first STA for allowing other STAs to transmit low latency data during a TXOP of the first STA, according to some embodiments.

FIG. 25 is a flow diagram showing a method performed by a first STA for transmitting low latency data during a TXOP of a second STA, according to some embodiments.

FIG. 26 is a flow diagram showing a method performed by a first STA for determining whether to wirelessly transmit low latency data to the AP during the random access uplink wireless transmission, according to some embodiments.

FIG. 27 is a flow diagram showing a method performed by an AP for allowing STAs to transmit low latency data during a TXOP of the AP, according to some embodiments.

FIG. 28 is a flow diagram showing a method performed by a first STA for allowing a second STA to transmit low latency data during a TXOP of the AP, according to some embodiments.

FIG. 29 is a flow diagram showing a method performed by a first STA for transmitting low latency data during a TXOP of the AP, according to some embodiments.

### DETAILED DESCRIPTION

One aspect of the present disclosure generally relates to wireless communications, and more specifically, relates to allowing the transmission of low latency (LL) data in wireless networks using preemption.

Some embodiments allow an access point (AP) to transmit low latency data in the middle of the transmission opportunity (TXOP) of a station (STA) by preempting the STA's TXOP. The STA's TXOP may be extended to compensate for the loss of TXOP due to the preemption. Also, some embodiments allow a first STA to transmit low latency data in the middle of the TXOP of a second STA by preempting the second STA's TXOP. The second STA's TXOP may be extended to compensate for the loss of TXOP due to the preemption. Also, some embodiments allow a STA to transmit low latency data in the middle of the TXOP of the AP by preempting the AP's TXOP. The AP's TXOP may be extended to compensate for the loss of TXOP due to the preemption.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

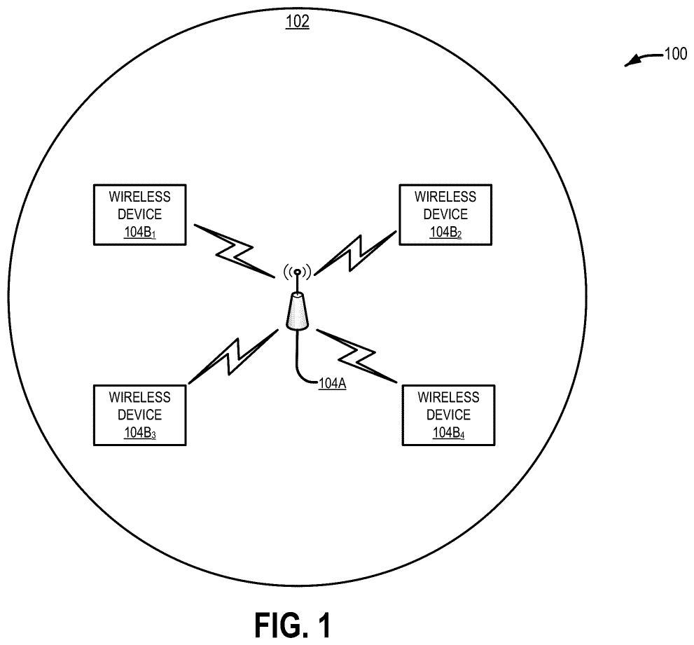

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs. Although shown with four non-AP STAs (e.g., the wireless devices 104B₁-104B₄), the WLAN 100 may include any number of non-AP STAs (e.g., one or more wireless devices 104B).

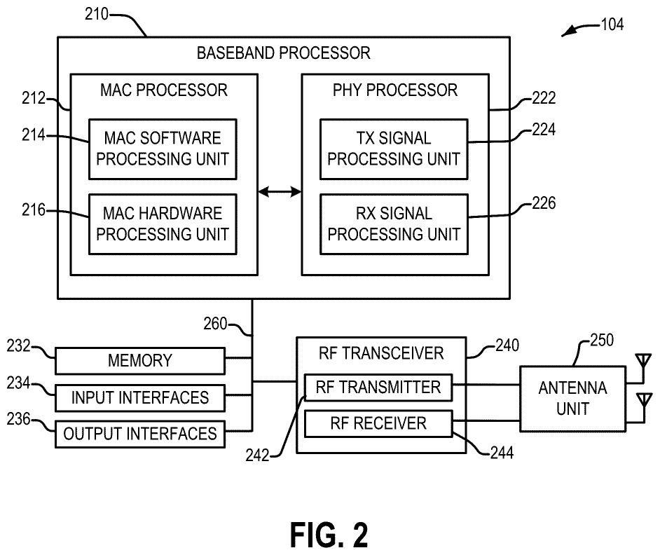

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

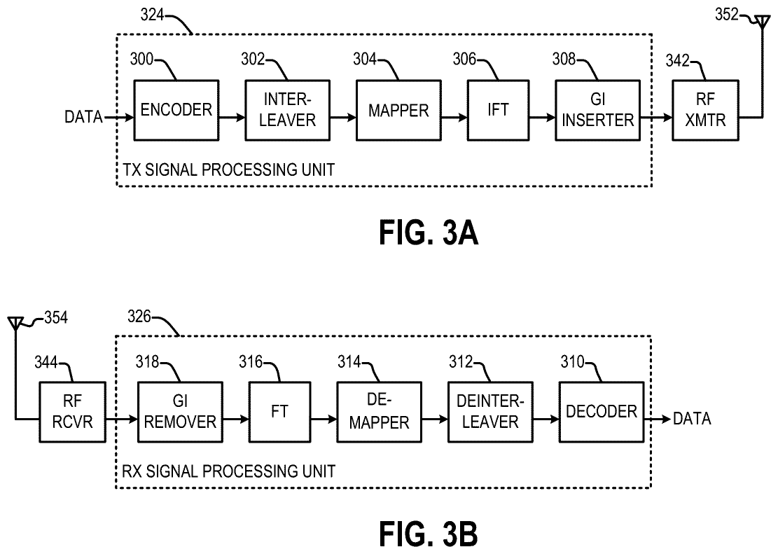

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

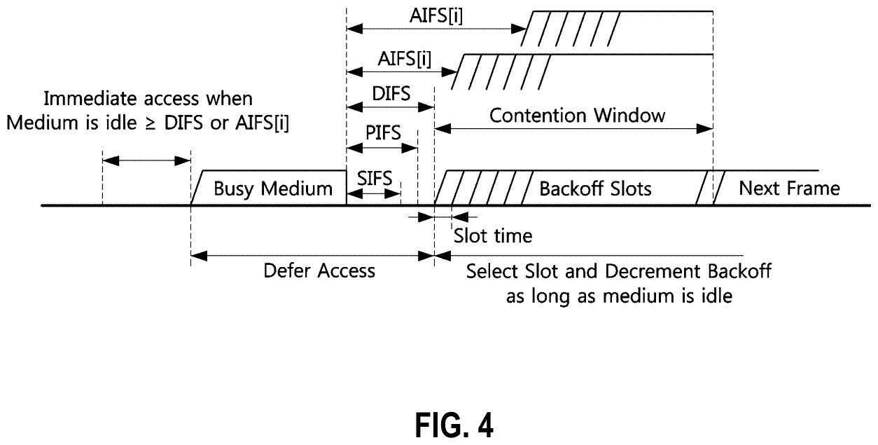

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

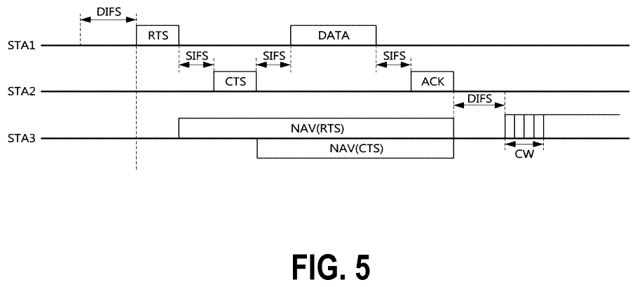

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

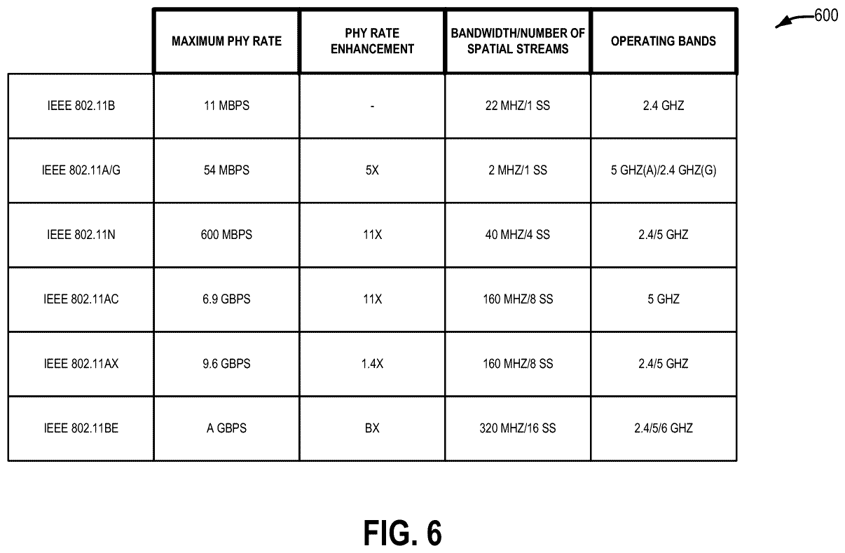

With clear demand for higher peak throughput/capacity in a WLAN, a new working group has been assembled to generate an amendment to IEEE 802.11. This amendment is called IEEE 802.11be (i.e., Extreme High Throughput (EHT)) and was created to support an increase to the peak PHY rate of a corresponding WLAN. Considering IEEE 802.11b through 802.11ac, the peak PHY rate has been increased by 5× to 11× as shown in FIG. 6, which presents a table 600 comparing various iterations of IEEE 802.11. In case of IEEE 802.11ax, the 802.11ax working group focused on improving efficiency, not peak PHY rate in dense environments. The maximum PHY rate (A Gbps) and PHY rate enhancement (Bx) for IEEE 802.11be could rely on the highest MCS (e.g., 4,096 QAM and its code rate).

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

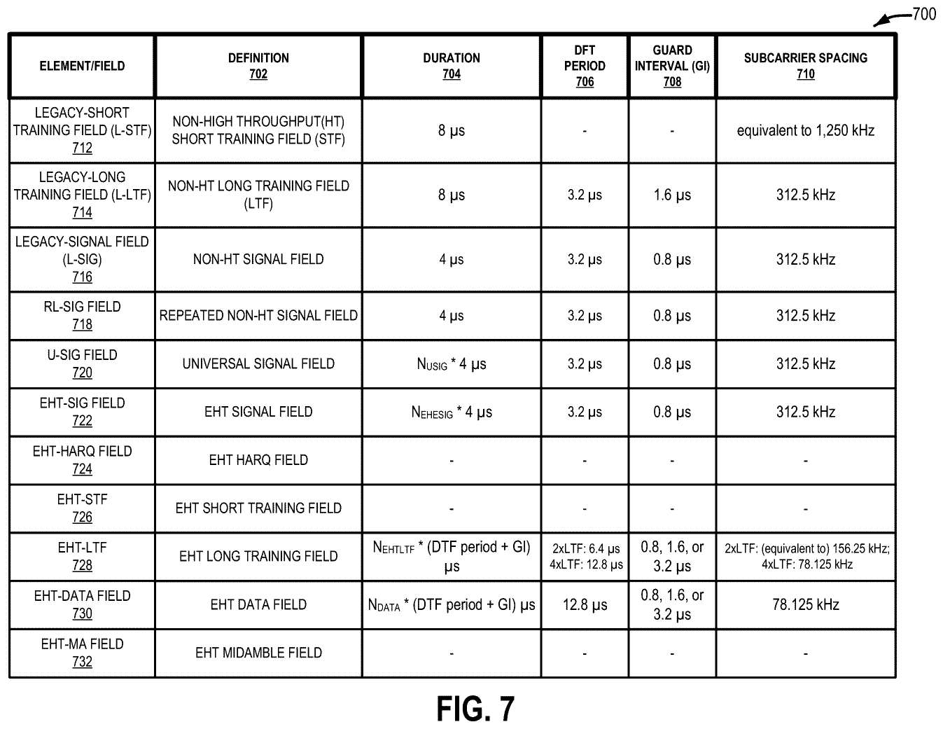

In some embodiments, a transmitting STA generates a PPDU frame and transmits it to a receiving STA. The receiving STA receives, detects, and processes the PPDU. The PPDU can be an EHT PPDU that includes a legacy part (e.g., a legacy short training field (L-STF), a legacy long training field (L-LTF), and a legacy signal (L-SIG) field), an EHT signal A field (EHT-SIG-A), an EHT signal B field (EHT-SIG-B), an EHT hybrid automatic repeat request field (EHT-HARQ), an EHT short training field (EHT-STF), an EHT long training field (EHT-LTF), and an EHT-DATA field. FIG. 7 includes a table 700, which describes fields of an EHT frame format. In particular, table 700 describes various fields that may be within the PHY preamble, data field, and midamble of an EHT frame format. For example, table 700 includes definitions 702, durations 704, Discrete Fourier transform (DFTs) periods 706, guard intervals (GIs) 708, and subcarrier spacings 710 for one or more of a legacy short training field (L-STF) 712, legacy long training field (L-LTF) 714, legacy signal field (L-SIG) 716, repeated L-SIG (RL-SIG) 718, universal signal field (U-SIG) 720, EHT signal field (EHT-SIG) 722, EHT hybrid automatic repeat request field (EHT-HARQ) 724, EHT short training field (EHT-STF) 726, EHT long training field (EHT-LTF) 728, EHT data field 730, and EHT midamble field (EHT-MA) 732.

The distributed nature of a channel access network, such as in IEEE 802.11 wireless networks, makes carrier sensing mechanisms important for collision free operation. The physical carrier sensing mechanism of one STA is responsible for detecting the transmissions of other STAs. However, it may be impossible to detect every single case in some circumstances. For example, one STA which may be a long distance away from another STA may see the medium as idle and begin transmitting a frame while the other STA is also transmitting. To overcome this hidden node, a network allocation vector (NAV) may be used. However, as wireless networks evolve to include simultaneous transmission/reception to/from multiple users within a single basic service set (BSS), such as uplink (UL)/downlink (DL) multi-user (MU) transmissions in a cascading manner, a mechanism may be needed to allow for such a situation. As used herein, a multi-user (MU) transmission refers to cases that multiple frames are transmitted to or from multiple STAs simultaneously using different resources. Examples of different resources are different frequency resources in OFDMA transmissions and different spatial streams in MU-MIMO transmissions. Therefore, DL-OFDMA, DL-MU-MIMO, UL-OFDMA, and UL-MU-MIMO are examples of MU transmissions.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HAPQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

To improve WLAN systems, AP cooperation has been discussed as a possible technology to be adopted in IEEE 802.11be, where there is high level classification depending on various AP cooperation schemes. For example, there is a first type of cooperation scheme in which data for a user is sent from a single AP (sometimes referred to as “coordinated”) and there is a second type of cooperation scheme in which data for a user is sent from multiple APs (sometimes referred to as “joint”).

For the coordinated scheme, multiple APs are 1) transmitting on the same frequency resource based on coordination and forming spatial nulls to allow for simultaneous transmission from multiple APs or 2) transmitting on orthogonal frequency resources by coordinating and splitting the spectrum to use the spectrum more efficiently. For the joint scheme, multiple APs are transmitting jointly to a given user.

As mentioned above, conventional WLANs allow stations to occupy channels or links for a relatively long period of time (e.g., by granting a transmission opportunity (TXOP) to a STA) to avoid having to compete for channel access with other STAs. However, this feature of conventional WLANs makes it difficult for low latency applications or STAs to obtain channel access opportunities, which makes it difficult to satisfy strict latency requirements.

Embodiments are described herein that allow an AP or a (non-AP) STA to transmit low latency data in the middle of another AP/STA's TXOP by preempting the TXOP. Three scenarios are described below. The scenarios may occur in the context of a wireless network that includes an AP and one or more STAs (e.g., STA1 to STAn). The first scenario is a scenario where the AP has low latency data to transmit during a TXOP holder STA's (STA1) TXOP. The second scenario is a scenario where a first STA (STAn) has low latency data to transmit during another STA's (STA1) TXOP. The third scenario is a scenario where a STA (STAn) has low latency data to transmit during an AP's TXOP.

### Scenario 1: AP has Low Latency Data to Transmit During STA1's Uplink TXOP

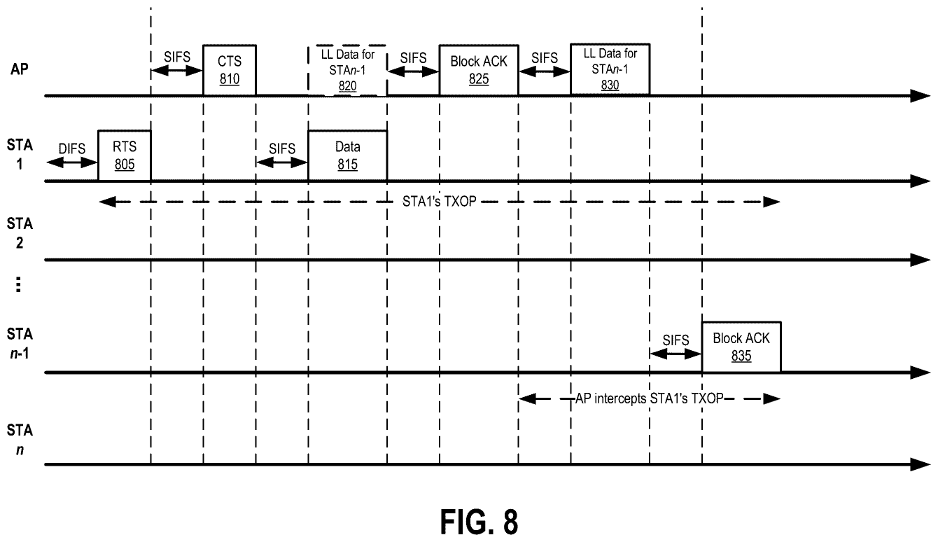

FIG. 8 is a diagram showing a scenario where an AP has low latency data to transmit to STAn−1 during STA1's uplink TXOP, according to some embodiments.

As shown in the diagram, after a DIFS interval, STA1 may transmit an RTS frame 805. After a SIFS interval, the AP may transmit a CTS frame 810.

After a SIFS interval, STA1 may transmit a data frame 815 (including non-LL data) to the AP during STA1's (uplink) TXOP. While the AP is receiving the data frame 810 from STA1, the AP may determine that it has low latency data 820 that has to be urgently transmitted to STAn−1. Low latency data is data that is to be transmitted with low latency (e.g., urgent data). What is considered low latency data can depend on the specific implementation.

After a SIFS interval, the AP may transmit a block ACK frame 825 that acknowledges the data frame 815 to STA1. After a SIFS interval, the AP may transmit a low latency data frame 830 that includes the low latency data to STAn−1. A low latency data frame may be a data frame that carries low latency data (e.g., urgent data).

After a SIFS interval, STAn−1 may transmit a block ACK frame 835 that acknowledges the low latency data frame 830 to the AP. Thus, the AP can be seen as preempting or intercepting STA1's TXOP to transmit the low latency data frame 830 to STAn−1.

However, during STA1's TXOP, STA1 is not able to recognize that the AP has low latency data to transmit to STAn−1. As a result, there is no way for the AP to transmit low latency data to STAn−1 during STA1's TXOP (as the AP is not allowed to neglect the Tx/Rx (transmit/receive) process between the AP and STA1 during STA1's TXOP). That is, conventional WLAN mechanisms do not allow the AP to transmit the low latency data frame 830 to STAn−1 during STA1's TXOP.

To allow the AP to transmit low latency data to STAn−1 during STA1's TXOP, the following features may be desirable: (1) STA1 should be able to directly/indirectly recognize that the AP has low latency data to transmit during STA1's TXOP; and (2) if STA1's TXOP is preempted by the AP and/or another STA (stolen by the AP and/or STAn−1) to transmit low latency data, STA1's TXOP should be extended by an appropriate length to ensure fairness (to reward STA1 for allowing the AP and/or another STA to preempt STA1's TXOP).

### Scenario 1 Feature 1

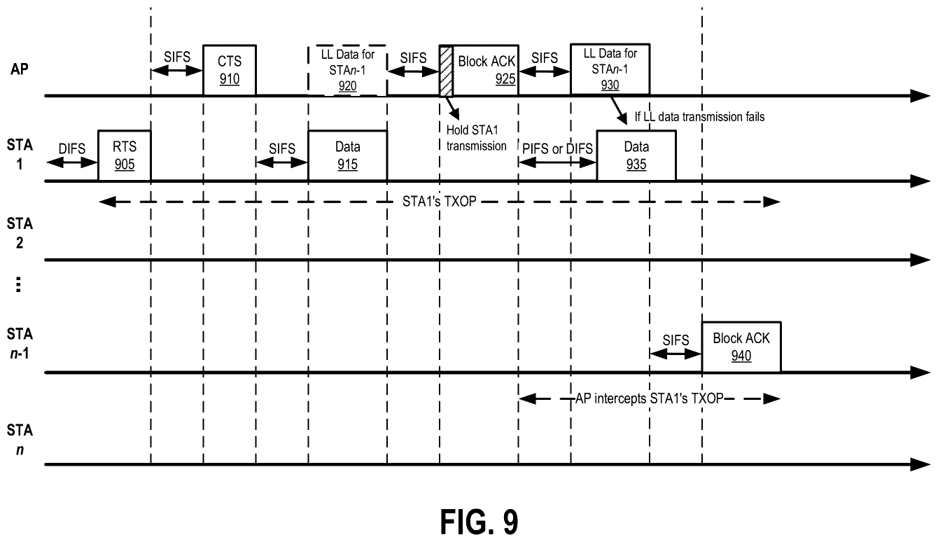

FIG. 9 is a diagram showing how the AP can preempt STA1's TXOP to transmit low latency data, according to some embodiments.

As shown in the diagram, after a DIFS interval, STA1 may transmit an RTS frame 905. After a SIFS interval, the AP may transmit a CTS frame 910.

After a SIFS interval, STA1 may transmit a data frame 915 (including non-LL data) to the AP during STA1's TXOP. While the AP is receiving the data frame 910 from STA1, the AP may determine that it has low latency data 920 that has to be urgently transmitted to STAn−1 (this particular example is one where the AP has low latency data to transmit to STAn−1 but the same technique described herein can be used herein to allow the AP to transmit low latency data to any other STA associated with the AP, including the TXOP holder STA (i.e., STA1)).

After a SIFS interval, the AP may transmit a block ACK frame 925 to STA1 that acknowledges the data frame 915. The block ACK frame 925 may include an indication that the AP has low latency data to transmit so STA1 should hold its transmission. The indication may serve as a preemption request indicator to indicate that preemption of the TXOP is being requested to transmit low latency data.

In an embodiment, the indication is included in a field of a preamble of the block ACK frame 925. For example, the indication may be included in a U-SIG field or a UHR-SIG (UHR stands for ultra-high reliability) field of the preamble. In an embodiment, the indication is included in a field of a media access control (MAC) protocol data unit (PDU) of the block ACK frame 925.

In an embodiment, the indication is a single bit. In an embodiment, the indication comprises multiple bits. In an embodiment, one of the bits comprising the indication indicates whether the indication applies to data included in the current frame or data included in a buffered (future) frame.

Upon receiving the block ACK frame 925 from the AP, STA1 may recognize that the AP has low latency data to transmit based on the indication included in the block ACK frame 925 (e.g., which could be included in the preamble of the block ACK frame 925 or the MPDU of the block ACK frame 925). As a result, STA1 may hold its transmission. For example, STA1 may hold its transmission by deciding not to use a SIFS interval to transmit data following the transmission of the block ACK frame 925, but use a longer IFS interval such as a PIFS interval or DIFS interval.

After a SIFS interval following the AP's transmission of the block ACK frame 925, the AP may transmit a low latency data frame 930 (that includes low latency data) to STAn−1. In this way, the AP is able to preempt STA1's TXOP to transmit low latency data to STAn−1.

It is noted that if both the AP and STA1 use the same IFS interval (e.g., SIFS interval) to transmit data, a collision may occur between AP and STA1. Thus, in an embodiment, STA1, which is the TXOP holder in this example, uses an interframe space interval that is longer than the interframe space interval used by the AP (e.g., AP uses SIFS interval, while STA1 uses PIFS interval or DIFS interval), which allows the AP to preempt STA1's TXOP following the transmission of the block ACK frame 925. That is, when STA1 recognizes that the AP has low latency data to transmit (e.g., based on the indication included in the block ACK frame), STA1 gives preference to the AP's transmission by using an IFS interval that is longer than the IFS interval used by the AP (which can be predetermined by the protocol). In an embodiment, the AP uses a SIFS interval following transmission of the block ACK frame 925 and STA1 uses a PIFS interval or DIFS interval (which are longer than SIFS) following transmission of the block ACK frame 925.

The use of different IFS intervals provides a benefit in the case that the AP's transmission of the low latency data frame 930 fails for whatever reason. For example, if the AP's transmission of the low latency data frame 930 fails, STA1 may still transmit a data frame 935 (e.g., after PIFS interval or DIFS interval), thereby preserving STA1's TXOP. When the channel is occupied through the use of an RTS/CTS protocol, other STAs are not allowed to access the channel during PIFS interval time. That is, the use of different IFS intervals gives preference to the AP (so that the AP can transmit low latency data), while still being able to preserve the TXOP for the TXOP holder if the AP's transmission fails.

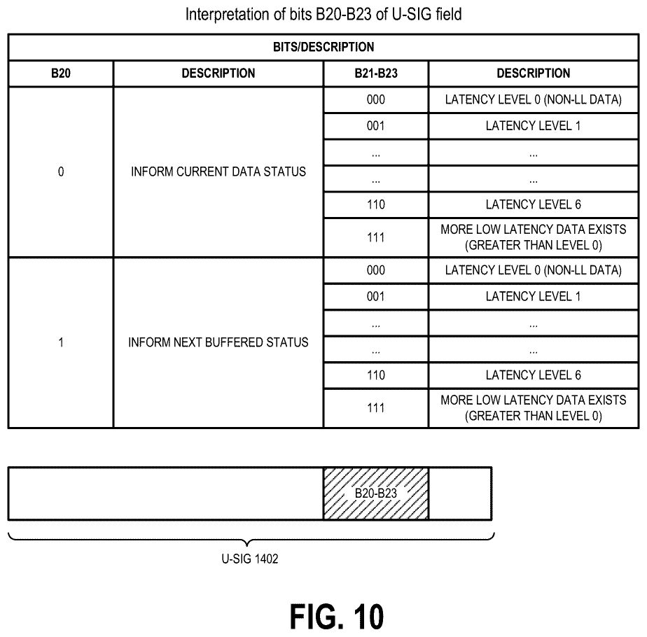

FIG. 10 is a diagram showing an interpretation of bits B20-B23 of the U-SIG field, according to some embodiments.

The example shown in the diagram assumes that bits B20-B23 of the U-SIG field 1402 (e.g., which are the disregard bits of an EHT PPDU U-SIG field) are used for indicating that the AP has low latency data to transmit.

Bits B21-B23 may be used to indicate the low latency level of low latency data. The low latency level of low latency data indicates the level of urgency of that data or the transmission priority of that data.

Bit B20 may be used to indicate whether the low latency level applies to the current frame or a future frame. As shown in the diagram, bit B20 being set to ‘0’ may indicate that the low latency level applies to data included in the current data frame and bit B20 being set to ‘1’ may indicate that the low latency level applies to data included in a future frame.

Also, as shown in the diagram, bits B21-B23 being set to ‘000’ may indicate low latency level 0 (non-LL (non-urgent) data), bits B21-B23 being set to ‘001’ may indicate low latency level 1, and bits B21-B23 being set to ‘110’ may indicate low latency level 6, which in this example is the highest low latency level (the most urgent). There may be other bit values indicating other low latency levels as depicted by the ellipsis in the diagram. Bits B21-B23 being set to ‘111’ may indicate that there exists more low latency data.

Thus, in this example, four bits (B20-B23) are used to indicate the existence/non-existence of low latency data and the low latency data's low latency level.

In an embodiment, the same bit encoding/interpretation or similar encoding/interpretation shown in the diagram can be used in a UHR-SIG field instead of a U-SIG field 1402 to indicate the existence of low latency data and the low latency level of the low latency data.

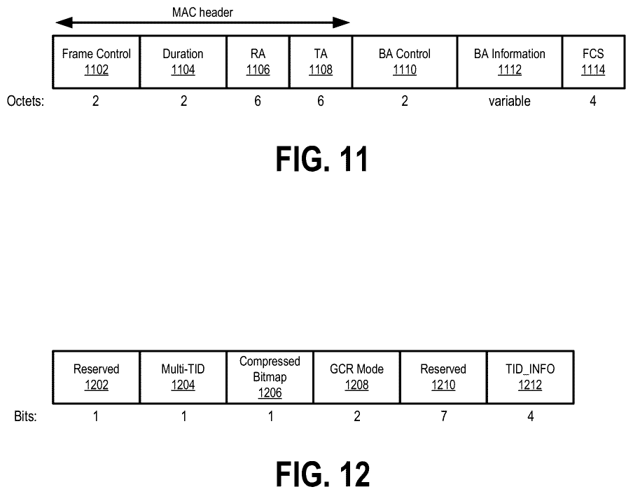

FIG. 11 is a diagram showing a block ACK frame format, according to some embodiments. As shown in the diagram, the block ACK frame format includes a frame control field 1102 (2 octets), a duration field 1104 (2 octets), a receiver address (RA) field 1106 (6 octets), a transmitter address (TA) field 1108 (6 octets), a BA control field 1110 (2 octets), a BA information field 1112 (variable length), and a frame check sequence (FCS) field 1114 (4 octets).

FIG. 12 is a diagram showing a BA control field format, according to some embodiments. As shown in the diagram, the BA control field format includes a reserved field 1202 (1 bit), a multi-TID (traffic identifier) field 1204 (1 bit), a compressed bitmap 1206 (1 bit), a GCR (groupcast with retries) mode field 1208 (2 bits), a reserved field 1210 (7 bits), and a TID_INFO field 1212 (4 bits).

In an embodiment, the indication that the AP has low latency data to transmit is included in a reserved subfield of a BA control field. The BA control field is a field of a block ACK frame (which is a MAC control frame).

### Scenario 1 Feature 2

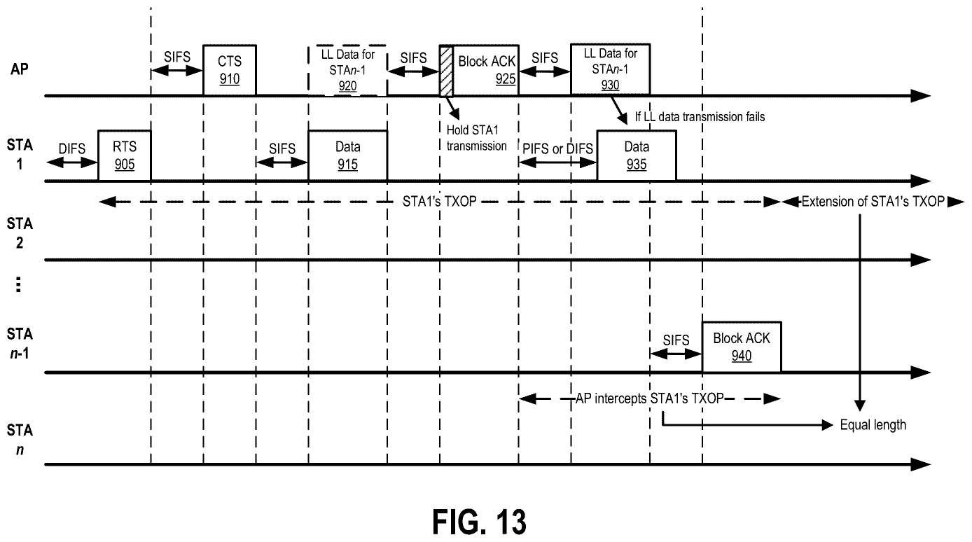

FIG. 13 is a diagram showing STA1's TXOP being extended to compensate for STA1's TXOP being preempted, according to some embodiments.

FIG. 13 is the same as FIG. 9 except that it shows that STA1's TXOP may be extended and that the length of the extension is equal to the length of the preemption of STA1's TXOP. In the example shown in the diagram, STA1 acquired its TXOP through fair competition with other STAs. However, to support the low latency data transmission of the AP, STA1 allowed the AP to preempt STA1's TXOP. Since STA1 allowed the AP to preempt STA1's TXOP, STA1 should be rewarded/compensated with an extension to its TXOP that corresponds to the length of time that STA1's TXOP was preempted by the AP and/or other STAs. To this end, in an embodiment, STA1 determines a TXOP compensation length that corresponds to the length of time that STA1's TXOP was preempted. In the context of the TXOP compensation length, “length” refers to a length of time (i.e., a duration).

In the example shown in the diagram, the intended receiver of the low latency data frame 930 is STAn−1. However, the other STAs such as STA1, STA2, and STAn may overhear the low latency data frame 930. Also, the other STAs may overhear the block ACK frame 940 transmitted by STAn−1. STA1 may calculate the length of time to transmit the low latency data frame 930 from the AP to STAn−1 based on the low latency data frame's 930 preamble. STA1 may determine the TXOP compensation length based on summing the “stolen TXOP duration time” and “residual TXOP duration time” (“residual TXOP duration” may be the duration that was remaining in the TXOP before the TXOP was preempted) In the example shown in the diagram, there is no “residual TXOP duration time” (because the ending time of the BA frame 940 coincides with the ending time of STA1's TXOP) and thus STA1 may only consider the “stolen TXOP duration time” and may be rewarded with an extension corresponding to the “stolen TXOP duration time.”

In an embodiment, STA1 determines the length of the low latency data frame 930 based on the L-SIG field in the physical layer (PHY) preamble. The L-SIG field is expected to be included in the UHR PPDU's preamble to support backwards compatibility. The L-SIG field may include a rate field, a length field, and a signal tail field. The length field of the L-SIG field may include a TXTIME variable. STA1 may estimate TXTIME based on decoding the length field (e.g., bits B5-B16) of the L-SIG field.

In an embodiment, STA1 determines the length of the low latency data frame 930 based on the U-SIG field in the PHY preamble. The U-SIG field is expected to be included in the preamble starting with Wi-Fi 7 (IEEE 802.11be) and in future Wi-Fi standards (e.g., UHR) for forwards compatibility. Thus, the U-SIG field is expected to be included not only in a UHR PPDU but also future Wi-Fi PPDUs. The U-SIG field may include a PHY version identifier field, a UL/DL field, a TXOP field, and so on. STA1 may estimate the channel occupation time by decoding the TXOP field (e.g., bits B13-B19) of the U-SIG field.

Thus, STA1 may determine the length of the low latency data frame 930 based on decoding the L-SIG field or U-SIG field of the low latency data frame's 930 preamble. STA1 may store this value in its buffer. It should be appreciated that there may be other ways for STA1 to determine/estimate the length of the low latency data frame 930.

When the AP successfully transmits the low latency data frame 930 to STAn−1 and STAn−1 transmits a block ACK frame 940 that acknowledges the low latency data frame 930, STA1 may overhear the block ACK frame 940 due to being part of the same BSS as STAn−1. STA1 may determine the length of the block ACK frame 140 based on decoding the L-SIG or U-SIG field of the block ACK frame's 140 preamble. STA1 may then determine the total TXOP compensation length based on summing the length of the low latency data frame 930 and the length of the block ACK frame 940 (as well as the length of any IFS intervals). For example, STA1 may determine the total TXOP compensation length using the below equation:

$$Compensation Time = T\_SIFS + T\_LL data + T\_SIFS + T\_BlockAck$$

In the above equation, “Compensation Time” is the TXOP compensation length, “T_SIFS” is the length of a SIFS interval, “T_LL data” is the length of the low latency data frame 930, and “T_BlockAck” is the length of the block ACK frame 940. The length may refer to a length of time.

STA1 may extend its TXOP by the TXOP compensation length. During the extended TXOP, STA1 may transmit other data to compensate for its TXOP being preempted to ensure fairness.

STA1 may recapture its TXOP once it determines that there is no more low latency data being transmitted. In an embodiment, STA1 determines whether there will be more low latency data transmitted using the following technique. When STA1 overhears the low latency data frame 930 during its own TXOP, STA1 may determine whether there are more low latency data frames to be transmitted based on bits included in a signal field of the low latency data frame's 930 preamble. If there is no other TX/RX happening for PIFS interval of time, STA1 may determine that there is no more low latency data to be transmitted. In this case, STA1 may reacquire its TXOP and extend its TXOP by the TXOP compensation length. In an embodiment, STA1 may extend its TXOP using a CTS to self frame, as will be described in additional detail herein below.

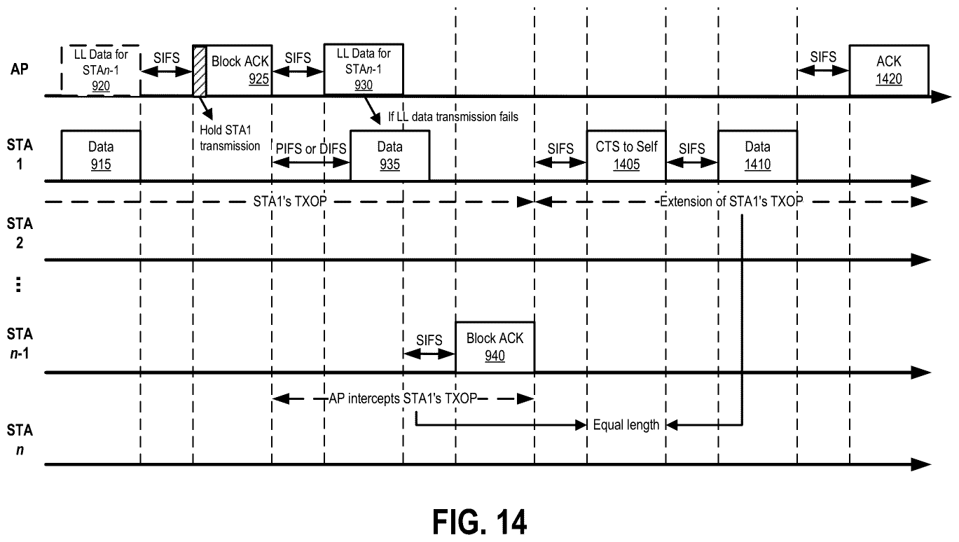

FIG. 14 is a diagram showing STA1 extending its TXOP using a CTS to self frame, according to some embodiments.

In the example shown in the diagram, the AP and STAs transmit frames 920-940 as described with reference to FIG. 9. In an embodiment, STA1 extends its TXOP using a CTS to self frame. For example, as shown in the diagram, after STAn−1 transmits the block ACK frame 940 to the AP, STA1 may transmit a CTS to self frame 1405 to extend its own TXOP to compensate for its TXOP being preempted (e.g., preempted by the AP). When STA1 transmits the CTS to self frame 1405, other STAs that overhear the CTS to self frame 1405 may set their network allocation vector (NAV) values to protect the transmission/reception of STA1. Thus, the use of the CTS to self frame 1405 helps guarantee the extension of STA1's TXOP. After a SIFS interval following transmission of the CTS to self frame 1405, STA1 may transmit a data frame 1410 during its extended TXOP.

Such technique to extend the TXOP and protect it may be applied in the other scenarios described below.

### Scenario 2: STAn has Low Latency Data to Transmit During STA1's Uplink TXOP

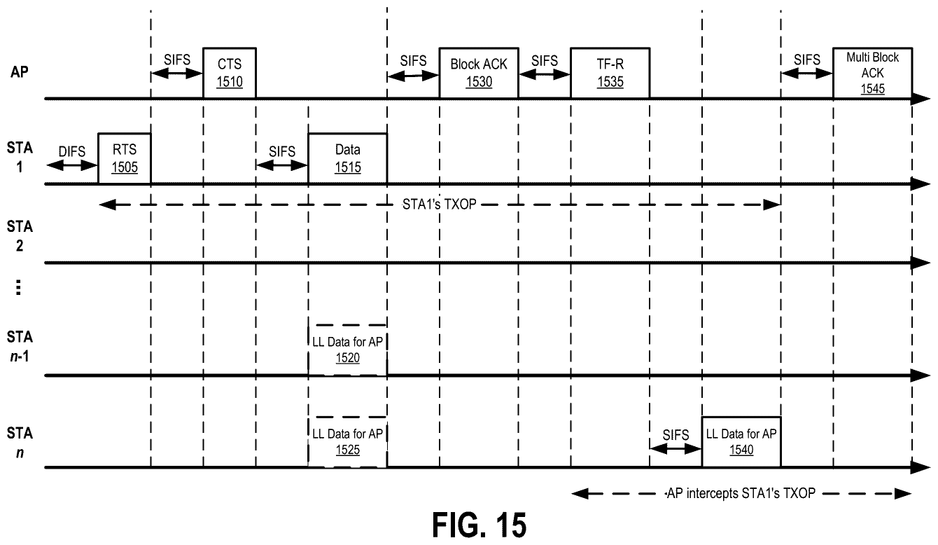

FIG. 15 is a diagram showing a scenario where STAn has low latency data to transmit to the AP during STA1's uplink TXOP, according to some embodiments.

As shown in the diagram, after a DIFS interval, STA1 may transmit an RTS frame 1505. After a SIFS interval, the AP may transmit a CTS frame 1510.

After a SIFS interval, STA1 may transmit a data frame 1515 (including non-LL data) to the AP during STA1's (uplink) TXOP. While STA1 is transmitting the data frame 1515 to the AP, STAn−1 and STAn may determine that they each have low latency data (low latency data 1520 and low latency data 1525) to transmit to the AP.

After a SIFS interval following transmission of the data frame 1515, the AP may transmit a block ACK frame 1530 that acknowledges the data frame 1515 to STA1. After a SIFS interval, the AP may transmit a trigger frame (TF-R) 1535 that schedules a random access uplink transmission. After a SIFS interval, STAn may transmit a low latency data frame 1540 that includes low latency data to the AP during the random access uplink transmission. After a SIFS interval, the AP may transmit a multi-block ACK frame 1545 that acknowledges the low latency data frame 1540 to STAn.

In the example shown in the diagram, the AP preempts STA1's TXOP to transmit a TF-R frame 1535 and receive a low latency data frame 1540 from STAn. This is not a typical situation in a conventional WLAN. In a conventional WLAN, the AP is not able to recognize that STAn has low latency data to transmit to the AP. Moreover, there is no way in a conventional WLAN to decide which STA is chosen to transmit low latency data to the AP (e.g., if both STAn−1 and STAn have low latency data to transmit to the AP, there is no way to determine which of these STAs is allowed to transmit low latency data to the AP).

To allow other STAs to transmit low latency data during STA1's TXOP, the following features may be desirable: (1) the AP should be able to directly/indirectly recognize that other STAs can have low latency data to transmit during STA1's TXOP and a STA should be chosen through fair competition to transmit low latency data; and (2) if STA1's TXOP is preempted by another STA (e.g., stolen by STAn) to transmit low latency data, STA1's TXOP should be extended by an appropriate length to ensure fairness (to reward STA1 for allowing another STA to preempt STA1's TXOP).

### Scenario 2 Feature 1

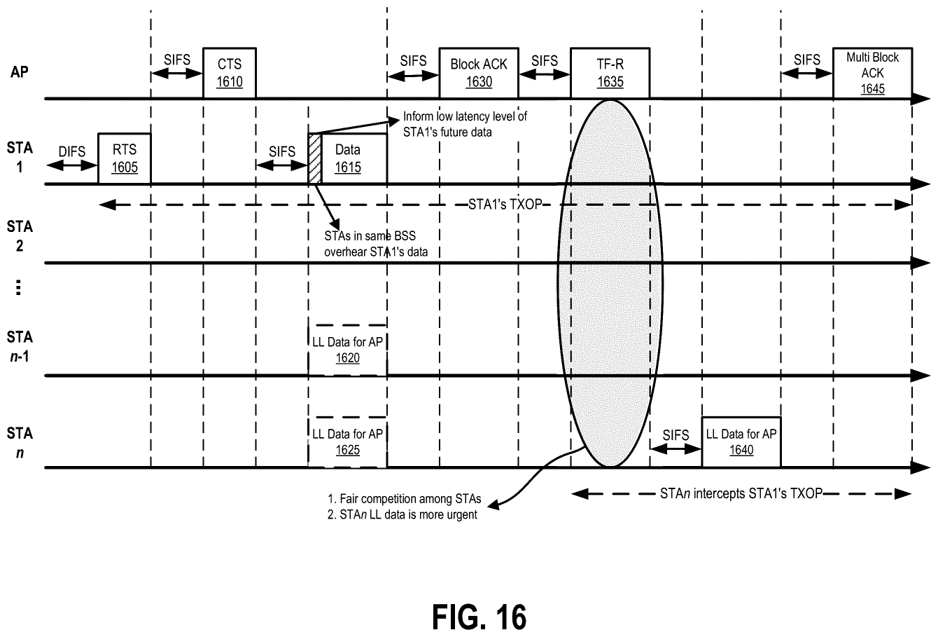

FIG. 16 is a diagram showing how STAn can preempt STA1's TXOP to transmit low latency data, according to some embodiments.

As shown in the diagram, after a DIFS interval, STA1 may transmit an RTS frame 1605. After a SIFS interval, the AP may transmit a CTS frame 1610.

After a SIFS interval, STA1 may transmit a data frame 1615 (including non-LL data) to the AP during STA1's TXOP. The data frame 1615 may include an indication that STA1 has low latency data to transmit. In an embodiment, the indication not only indicates that the STA1 has low latency data to transmit but also indicates the low latency level of the low latency data (e.g., similar to the indication included in the block ACK frame 925 used in scenario 1 described above). The low latency data may be data that is buffered at STA1 that is to be transmitted after data frame 1615. In this example, AP, STA2, STAn−1, and STAn have the same BSS color as STA1 so they may be able to overhear the data frame 1615 transmitted by STA1 to the AP.

While STA1 is transmitting the data frame 1615 to the AP, STAn−1 and STAn may determine that they each have low latency data (low latency data 1620 and low latency data 1625) to transmit to the AP. STAn−1 and STAn may determine the low latency level of STA1's low latency data based on decoding the overheard data frame 1615 transmitted by STA1 (e.g., based on the indication included therein).

After a SIFS interval following the reception of the data frame 1615, the AP may transmit a block ACK frame 1630 that acknowledges the data frame 1615 to STA1.

When the AP receives the data frame 1615 from STA1, it may determine that STA1 has low latency data to transmit (based on the indication included in the data frame 1615). However, to determine whether any other STAs have more urgent low latency data to transmit, the AP may transmit a TF-R frame 1635 that schedules a random access uplink transmission (e.g., the TF-R frame 1635 may allocate a random access resource unit (RU)). Thus, when STA1 transmits the data frame 1615 to the AP, STA1 may indicate in the data frame 1615 whether STA1 has low latency data to be transmitted or not. When the AP receives the data frame 1615 from STA1, the AP may decide whether polling is needed or not to support the solicitation of low latency data. If the AP decides that polling is needed, the AP may transmit the TF-R frame 1635 to solicit low latency data from STAs.

The STAs that receive the TF-R frame 1635 may determine whether they are allowed to transmit their low latency data to the AP during the random access uplink transmission based on the low latency level of their own low latency data and the low latency level of STA1's low latency data (e.g., which can be determined based on overhearing STA1's data frame 1615). In an embodiment, a STA determines that it is not allowed to participate in the random access uplink transmission if its low latency data is not as urgent as STA1's low latency data. The decision of which STA gets to transmit low latency data during the random access uplink transmission may be made based on the low latency levels of the low latency data at the STAs and fair competition among the STAs. In the example shown in the diagram, it is assumed that STAn has the most urgent low latency data so STAn transmits a low latency data frame 1640 to the AP during the random access uplink transmission (after a SIFS interval following transmission of the TF-R frame 1635).

After a SIFS interval, the AP transmits a multi block ACK frame 1645 that acknowledges the low latency data frame 1640.

The STAs that receive the TF-R frame 1635 may determine whether they are allowed to transmit during the random access uplink transmission according to a predetermined function/algorithm. For example, a STA may set/define an OFDMA contention window (OCW) value based on the low latency level of the STA's low latency data, determine an OFDMA backoff (OBO) value by selecting an arbitrary integer between 0 and the OCW value, increment the OBO value by a certain amount, and determine whether the OBO value is greater than or equal to a predefined threshold value. The STA may determine that it is allowed to transmit during the random access uplink transmission if the resulting OBO value is greater than or equal to the predefined threshold value and determine that it is not allowed to transmit during the random access uplink transmission if the resulting OBO value is less than the predefined threshold value. If the STA is allowed to transmit during the random access uplink transmission, the STA may transmit its low latency data to the AP during the random access uplink transmission using a random access resource unit (e.g., the random access resource unit may have been specified in the TF-R frame 1635).

As an example in the context of the situation shown in FIG. 16, the TF-R frame 1635 transmitted by the AP may indicate that there is one usable random access resource unit and the STAs may be aware of this. Also, it is assumed that STA1 has low latency data with low latency level 3, STAn−1 has low latency data with low latency level 3, and STAn has low latency data with low latency level 6 (e.g., the most urgent data), and the low latency level is used as the OCW value. Each STA may randomly select an integer between 0 and its OCW value to determine the OBO value. In this example, it is assumed that STA1's OBO value is 3, STAn−1's OBO value is 2 and STAn's OBO value is 6. Thereafter, each STA may increment its OBO value by the number of random access resource units available in the random access uplink transmission. In this example, there is one random access resource unit available in the random access uplink transmission. Thus, STA1's OBO value becomes 4, STAn−1's OBO value becomes 3 and STAn's OBO value becomes 7 (that is, each OBO value is incremented by 1). Each STA may then determine whether its OBO value is greater than or equal to the predefined threshold value. In this example, the predefined threshold value is 7. As such, STAn may determine that it is allowed to transmit during the random access uplink transmission (its OBO value is greater than or equal to the threshold value). Thus, STAn may transmit its low latency data to the AP during the random access uplink transmission using the random access resource unit.

In an embodiment, the OCW value, the OBO value, and the predefined threshold value are defined as follows (this may be referred to as algorithm 1):
1) OCW_min=the low latency level of the STA's buffered low latency data that it wishes to transmit to the AP (e.g., OCW_min for STA1, STA2, and STA3 may be set to 3, 3, and 6, respectively);

2) OCW_max=the highest low latency level (e.g., low latency level 6 according to the example shown in FIG. 10);
3) OBO=random_integer (0, OCW_min) (i.e., a random integer between 0 and OCW_min) (e.g., OBO for STA1, STA2, and STA3 may be set to 1, 2, and 5, respectively);
4) If the OBO value is greater than the number of random access resource units, the STA selects one of the random access resource units to use for data transmission—if the OBO value is not greater than the number of random access resource units, the STA performs steps 5 and 6 (e.g., assuming the number of random access resource units is 2, STA3 may transmit low latency data using a random access resource unit (since STA3's OBO is greater than 2) but STA1 and STA2 may not);
5) threshold_value is set to a predetermined value (e.g., threshold_value=highest low latency level (e.g., low latency level 6)+the number of random access resource units (e.g., 2 in the above example)=8);
6) The STA adds/sums the number of random access resource units to the OBO value and selects one of the random access resource units to use for data transmission if the sum is greater than or equal to threshold_value (e.g., neither STA1 or STA2 may transmit low latency data because their respective sums (OBO+number of random access resource units) are not greater than or equal to threshold_value−STA1's sum is 3 (1 (OBO)+2 (number of random access resource units)=3) and STA2's sum is 4 (2 (OBO)+2 (number of random access resource units)=4).

While a certain way to determine/define the OBO value, the OCW value, and the predefined threshold value is described above, it should be appreciated that these values can be determined/defined in other ways.

If there is only one random access resource unit available and there are multiple STAs having an OBO value that exceeds the predefined threshold value, a resource unit collision may occur and the transmission of low latency data may fail. Moreover, even if the number of STAs having an OBO value that exceeds the predefined threshold value is less than the number of available random access resource units, there could still be a scenario where multiple STAs select/use the same random access resource unit. Likewise, in this case, a resource unit collision may occur and the transmission of low latency data may fail. In an embodiment, the AP may transmit a multiuser block ACK (MU-BA) frame to inform the STAs whether the transmission of low latency data was successful or not. In an embodiment, if the transmission of low latency data fails, the STAs may reset their OCW values and OBO values, and repeat above-described process to transmit their low latency data again.

In an embodiment, the new/reset OCW value and OBO value are calculated as follows:

$$OCW\_new = OCW\_old + 1 ; \qquad 1 )$$

2) If OCW_new is greater than or equal to OCW_max, OCW_new is set to be OCW_max;

$$OBO = random integer ( 0 , OCW\_new ) \qquad 3 )$$

4) Repeat steps 4, 5, and 6 of algorithm 1 described above.

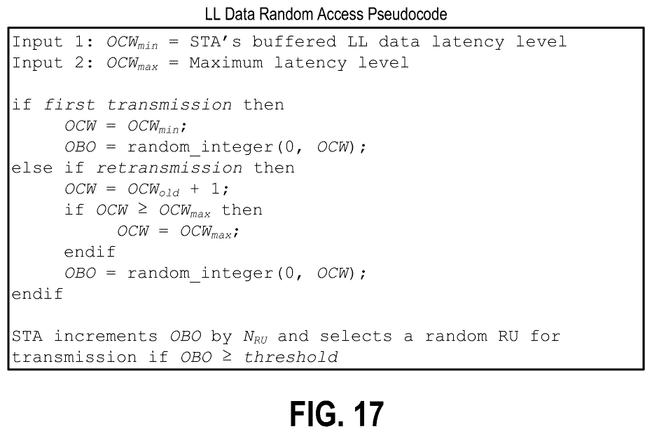

FIG. 17 is a diagram showing pseudocode for determining whether a STA is allowed to transmit during an (OFDMA) random access uplink transmission, according to some embodiments.

As shown in the diagram, OCWₘᵢₙ is set to the low latency level of the STA's buffered low latency data and OCWₘₐₓ is set to the maximum latency level.

If this is the first attempt at transmission, OCW is set to OCWₘᵢₙ, and OBO is set to a random integer between 0 and OCW.

Otherwise, if this is not the first transmission (it is a retransmission (e.g., because the initial transmission failed)), then OCW is set to the previous OCW incremented by one.

If OCW is greater than or equal to OCWₘₐₓ, then OCW is set to be equal to OCWₘₐₓ. OBO is then set to be a random integer between 0 and OCW.

OBO is then incremented by the number of resource units (N_{RU}). The STA selects a random resource unit to use for low latency data transmission if OBO is greater than or equal to a predefined threshold.

### Scenario 2 Feature 2

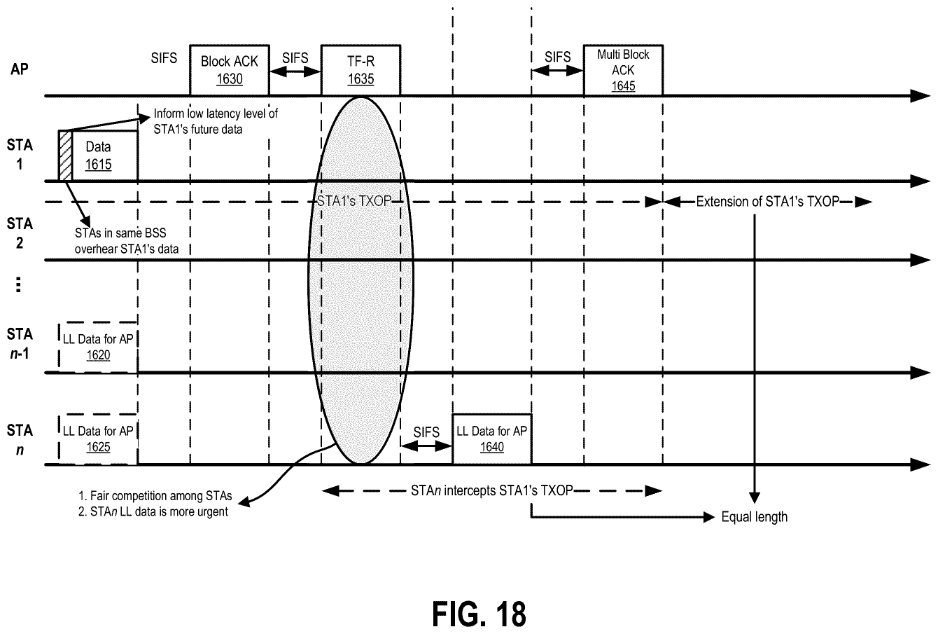

FIG. 18 is a diagram showing STA1's TXOP being extended to compensate for STA1's TXOP being preempted, according to some embodiments.

FIG. 18 shows the same interactions between APs and STA as FIG. 16 (starting with data frame 1615) except that it shows that STA1's TXOP may be extended and that the length of the extension is equal to the length of the preemption of STA1's TXOP. STA1's TXOP was preempted after STA1 received the block ACK frame 1630. STA1 may determine a TXOP compensation length based on the length of the TF-R frame 1635, the length of the low latency data frame 1640, and the length of the multi-block ACK frame 1645 (as well as any IFS intervals). Following the AP's transmission of the multi-block ACK frame 1645, STA1 may extend its TXOP by the TXOP compensation length (e.g., using a CTS to self frame as described above).

### Scenario 3: STA has Low Latency Data to Transmit During AP's Downlink TXOP

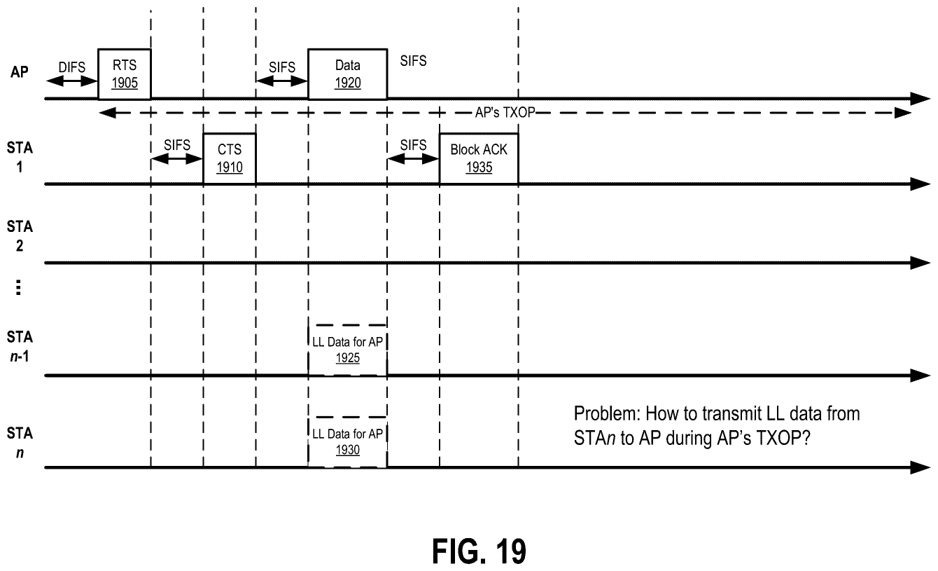

FIG. 19 is a diagram showing a scenario where a STAs have low latency data to transmit to the AP during the AP's downlink TXOP, according to some embodiments.

As shown in the diagram, after a DIFS interval, AP may transmit an RTS frame 1905. After a SIFS interval, the STA1 may transmit a CTS frame 1910.

After a SIFS interval, the AP may transmit a data frame 1920 (including non-LL data) to STA1 during the AP's TXOP. While the AP is transmitting the data frame 1920 to STA1, STAn−1 and STAn may determine that they have low latency data (low latency data 1925 and low latency data 1930) that has to be urgently transmitted to the AP. As previously mentioned, what is considered low latency data can depend on the specific implementation.

With conventional WLAN mechanisms, the AP is not able to recognize that STAn−1 and STAn have low latency data to transmit. One way to solve this problem is to have the AP stop its transmission and to periodically check with STAs to see if they have low latency data to transmit. However, it is highly inefficient for the AP to stop its transmission and check for low latency data that may or may not exist.

To allow STAs to transmit low latency data to the AP during the AP's TXOP, the following features may be desirable: (1) the AP should be able to directly/indirectly recognize that STAs may have low latency data to transmit; and (2) if AP's TXOP is preempted by a STA (e.g., stolen by STAn) to transmit low latency data, the AP's TXOP should be extended by an appropriate length to ensure fairness (to reward AP for allowing a STA to preempt the AP's TXOP).

### Scenario 3 Feature 1

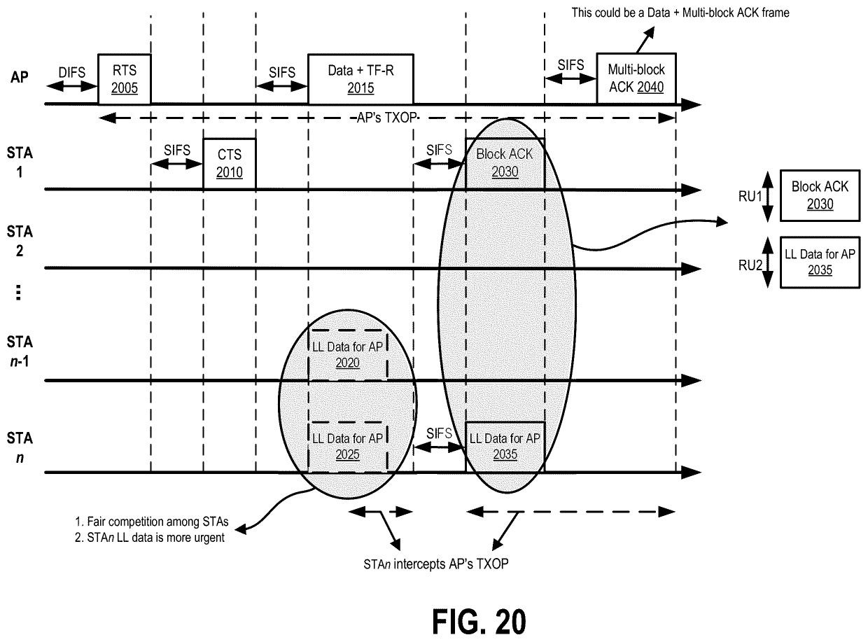

FIG. 20 is a diagram showing how STAn can preempt the AP's TXOP to transmit low latency data, according to some embodiments.

As shown in the diagram, after a DIFS interval, the AP may transmit an RTS frame 2005. After a SIFS interval, STA1 may transmit a CTS frame 2010.

After a SIFS interval, the AP may transmit a combined data frame and trigger frame 2015 (data+TF-R) during the AP's TXOP. The combined data frame and trigger frame may include a data frame portion (including non-LL data) that is intended for STA1 and a trigger frame portion that schedules an uplink transmission by STA1, as well as a random access uplink transmission. While the AP is transmitting the combined data frame and trigger frame 2015, STAn−1 and STAn may determine that they each have low latency data that has to be urgently transmitted to the AP (low latency data 2020 and low latency data 2025, respectively). The trigger frame portion of the combined data frame and trigger frame 2015 may be used to check whether any STAs have low latency data to transmit to the AP (in this sense it provides a preemption request enabled functionality). If any STAs have low latency data to transmit, they can use a resource unit allocated by the trigger frame portion of the combined data frame and trigger frame 2015 to transmit low latency data using an OFDMA transmission scheme. Thus, the combined data frame and trigger frame 2015 may be considered as being an instance of a combined data frame and preemption request enabled frame.

After a SIFS interval following the transmission of the combined data frame and trigger frame 2015, STA1 may transmit a block ACK frame 2030 that acknowledges the data frame portion of the combined data frame and trigger frame 2015 to the AP using a resource unit allocated to the STA1 by the combined data frame and trigger frame 2015.

STAs that have low latency data to transmit to the AP (e.g., STAn−1 and STAn) may determine whether they are allowed to transmit low latency data during the random access uplink transmission (e.g., using the OCW/OBO algorithm described above when describing scenario 2) and the STAs that are allowed to transmit low latency data may transmit a low latency data frame (including low latency data) to the AP during the random access uplink transmission using a random access resource unit allocated by the combined data frame and trigger frame 2015.

In the example shown in the diagram, it is assumed that the trigger frame portion of the combined data frame and trigger frame 2015 allocates two resource units for uplink transmission—a first resource unit (RU1) is allocated for STA1 and a second resource unit (RU2) is allocated as a random access resource unit. Also, in this example, it is assumed that STAn determines that it is allowed to transmit low latency data during the random access uplink transmission (e.g., because it has more urgent data to transmit to the AP compared to STAn−1). As such, STA1 transmits the block ACK frame 2030 to the AP using RU1 and STAn transmits a low latency data frame 2035 to the AP using RU2. The transmission of the block ACK frame 2030 and the low latency data frame 2035 may be simultaneous (e.g., using uplink OFDMA transmission techniques).

After a SIFS interval following the simultaneous transmission of the block ACK frame 2030 and the low latency data frame 2035, the AP may transmit a multi-block ACK frame 2040 that acknowledges the block ACK frame 2030 and the low latency data frame 2035. In an embodiment, the AP transmits a combined data frame and multi-block ACK frame instead of the multi-block ACK frame. The combined data frame and multi-block ACK frame may include a data frame portion intended for a STA, as well as a multi-block ACK frame portion that acknowledges the block ACK frame 2030 and the low latency data frame 2035.

In an embodiment, if STA1 determines that it has low latency data to transmit (before transmitting the block ACK frame 2030), STA1 may include an indication in the block ACK frame 2030 that indicates that STA1 has low latency data to transmit so the AP should hold its transmission (e.g., similar to the indication included in the block ACK frame 925 in FIG. 9). In this case, STA1 may transmit a low latency data frame (including low latency data) to the AP after a SIFS interval following transmission of the block ACK frame 2030 and the AP may hold off on transmission by using a longer IFS interval (e.g., PIFS interval or DIFS interval). Thus, the trigger frame portion of the combined data frame and trigger frame 2015 may be interpreted as being equivalent to asking STAs whether they have low latency data or not. A STA that has low latency data to transmit (e.g., STA1) may respond by transmitting a frame indicating that it has low latency data to transmit (e.g., a block ACK frame 2030 that includes an indication that STA1 has low latency data to transmit).

The approach described above with reference to FIG. 20 provides advantages over other approaches. For example, one approach to allow STAs to transmit low latency data during the AP's TXOP would be for the AP to periodically transmit a trigger frame to give STAs an opportunity to transmit low latency data to the AP. However, this can result in the waste of resources. In the worst case, if there are no STAs that have low latency data to transmit to the AP, the AP loses an opportunity to transmit data, wastes resources transmitting a trigger frame to STAs that will not make use of the random access uplink transmission scheduled by the trigger frame, and the AP's TXOP is terminated. Also, the idle time of the overall radio resources becomes longer. From the point of view of the AP, there is a benefit of providing opportunities to STAs to transmit low latency data by periodically transmitting a trigger frame, but from the viewpoint of overall system performance, this results in a significant loss because no meaningful action is taken if no STAs have low latency data to transmit. In contrast, with the approach described above that uses the combined data frame and trigger frame, even if there are no STAs that have low latency data to transmit to the AP, other STAs in the same BSS may transmit non-LL data. That is, even if there are no STAs that have low latency data to transmit, STAs may still transmit non-LL data to the AP during the random access uplink transmission (e.g., using a random access resource unit). Also, the TXOP acquired by the AP is not terminated early.

### Scenario 3 Feature 2

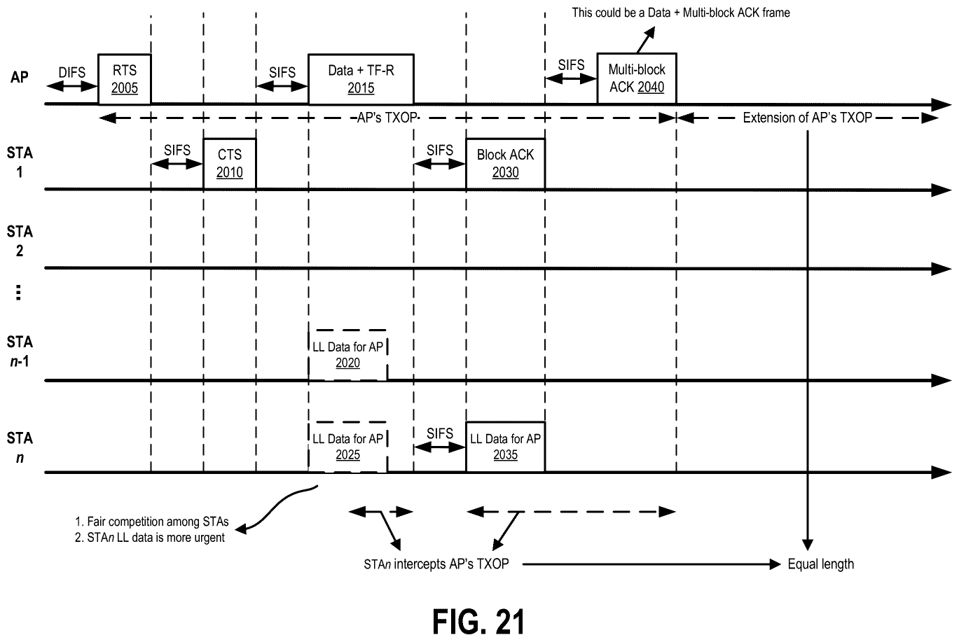

FIG. 21 is a diagram showing AP's TXOP being extended to compensate for AP's TXOP being preempted, according to some embodiments.

FIG. 21 shows the same interactions between APs and STA as FIG. 20 except that it shows that the AP's TXOP may be extended and that the length of the extension is equal to the length of the preemption of the AP's TXOP. The AP may determine the TXOP compensation length based on the length of the trigger frame portion of the combined data frame and trigger frame 2015, the increase in the length of transmission time due to the use of uplink OFDMA (e.g., splitting the resource units instead of being able to receive the block ACK frame 2030 using the entire bandwidth), and the length of the multi-block ACK frame 2040. For example, the AP may determine the TXOP compensation length by summing these lengths (as well as any IFS intervals). Following the AP's transmission of the multi-block ACK frame 2040, the AP may extend its TXOP by the TXOP compensation length (e.g., using a CTS to self frame as described above).

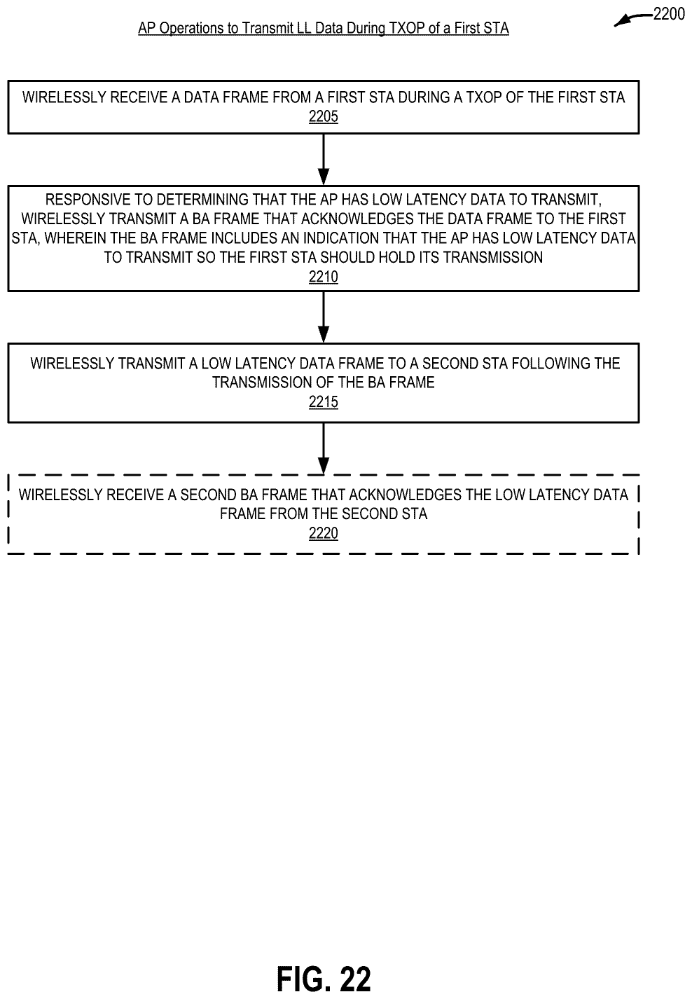

Turning now to FIG. 22, a method 2200 performed by an AP will be described for transmitting low latency data during a TXOP of a first STA, in accordance with an example embodiment. The AP may be implemented by a wireless device.

Additionally, although shown in a particular order, in some embodiments the operations of the method 2200 (and the other methods shown in the other figures) may be performed in a different order. For example, although the operations of the method 2200 are shown in a sequential order, some of the operations may be performed in partially or entirely overlapping time periods.

At operation 2205, the AP wirelessly receives a data frame from the first STA during the TXOP of the first STA.

At operation 2205, responsive to determining that the AP has low latency data to transmit, the AP wirelessly transmits a block acknowledgement (BA) frame that acknowledges the data frame to the first STA, wherein the BA frame includes an indication that the AP has low latency data to transmit so the first STA should hold its transmission. The BA frame may be a standard BA frame, an enhanced BA frame, or a multi-BA frame. In an embodiment, the indication that the AP has low latency data to transmit is included in a field of a preamble of the BA frame. In an embodiment, the field of the preamble is a U-SIG field. In another embodiment, the field of the preamble is a UHR-SIG field. In an embodiment, the indication that the AP has low latency data to transmit is included in a field of a MPDU of the BA frame. In an embodiment, the field is included in a BA control field of the BA frame. In an embodiment, the indication that the AP has low latency data to transmit comprises four bits. In an embodiment, three of the four bits is used for indicating a low latency level of low latency data and a remaining one of the four bits is use for indicating whether the low latency level is for low latency data included in a current frame or a future frame.

At operation 2215, the AP wirelessly transmits a low latency data frame to a second STA following the transmission of the BA frame. In an embodiment, the low latency data frame is transmitted after a first interframe space interval following the transmission of the BA frame, wherein the first interframe space interval is shorter than a second interframe space interval that is to be used by the first STA following the transmission of the BA frame. In an embodiment, the indication that the AP has low latency data to transmit being included in the BA frame causes the first STA to use the second interframe space interval when attempting to access a wireless channel. In an embodiment, the first interframe space interval is a SIFS interval and the second interframe space interval is a PIFS interval or a DIFS interval. In an embodiment, the AP wirelessly receives a data frame from the first STA after the second interframe space interval following the transmission of the BA frame due to a transmission failure of the low latency data frame. In an embodiment, the second STA is the same as the first STA.

In an embodiment, at operation 2220, the AP wirelessly receives a second BA frame that acknowledges the low latency data frame from the second STA.

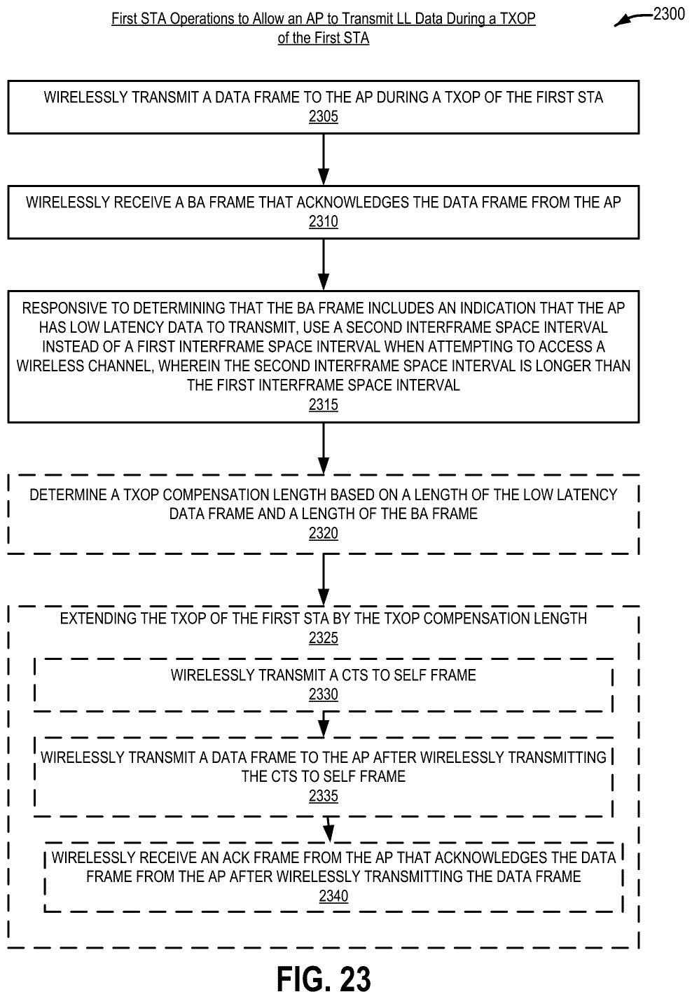

Turning now to FIG. 23, a method 2300 performed by a first STA will be described for allowing an AP to transmit low latency data, in accordance with an example embodiment. The first STA may be implemented by a wireless device.

At operation 2305, the first STA wirelessly transmits a data frame to the AP during a TXOP of the first STA.

At operation 2310, the first STA wirelessly receives a BA frame that acknowledges the data frame from the AP. The BA frame may be a standard BA frame, an enhanced BA frame, or a multi-BA frame.

At operation 2315, responsive to determining that the BA frame includes an indication that the AP has low latency data to transmit, the first STA uses a second interframe space interval instead of a first interframe space interval when attempting to access a wireless channel, wherein the second interframe space interval is longer than the first interframe space interval.

In an embodiment, at operation 2320, the first STA determines a TXOP compensation length based on a length of the low latency data frame and a length of the BA frame. In an embodiment, the length of the low latency data frame is determined based on a L-SIG field or a U-SIG field of a preamble of the low latency data frame. In an embodiment, the length of the BA frame is determined based on a L-SIG field or a U-SIG field of a preamble of the BA frame.

In an embodiment, at operation 2325, the first STA extends the TXOP of the first STA by the TXOP compensation length. In an embodiment, operation 2325 involves operations 2330-2340.

At operation 2330, the first STA wirelessly transmits a CTS to self frame. At operation 2335, the first STA wirelessly transmits a data frame to the AP after wirelessly transmitting the CTS to self frame. At operation 2340, the first STA wirelessly receives an ACK frame that acknowledges the data frame from the AP after wirelessly transmitting the data frame.

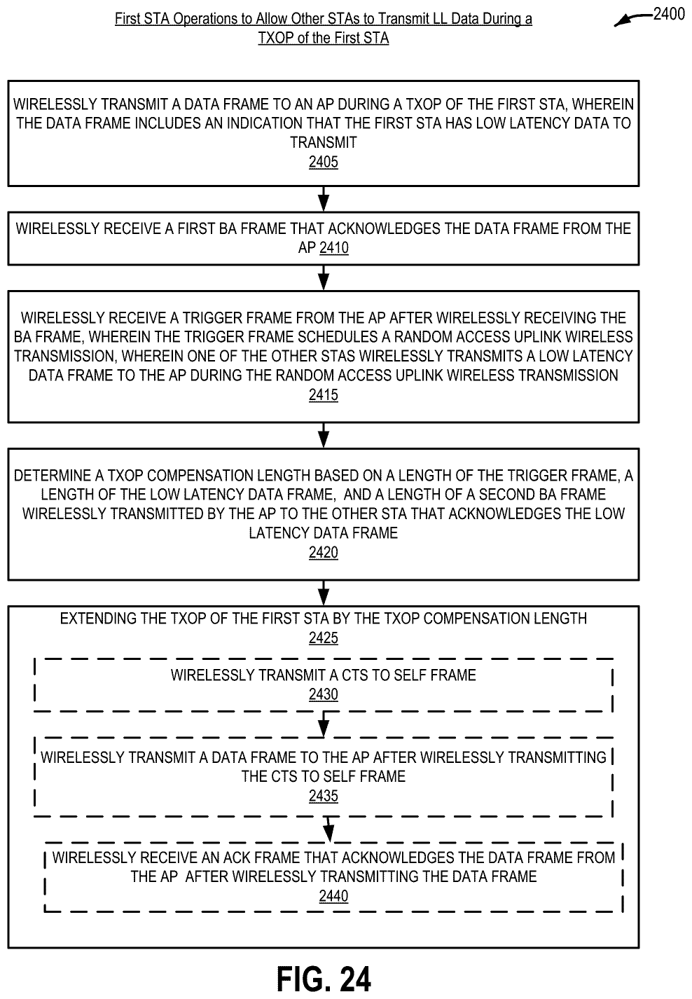

Turning now to FIG. 24, a method 2400 performed by a first STA will be described for allowing other STAs to transmit low latency data during a TXOP of the first STA, in accordance with an example embodiment. The first STA may be implemented by a wireless device.

At operation 2405, the first STA wirelessly transmits a data frame to an AP during a TXOP of the first STA, wherein the data frame includes an indication that the first STA has low latency data to transmit.

At operation 2410, the first STA wirelessly receives a first BA frame that acknowledges the data frame from the AP. The first BA frame may be a standard BA frame, an enhanced BA frame, or a multi-BA frame.

At operation 2415, the first STA wirelessly receives a trigger frame from the AP after wirelessly receiving the first BA frame, wherein the trigger frame schedules a random access uplink wireless transmission, wherein one of the other STAs wirelessly transmits a low latency data frame to the AP during the random access uplink wireless transmission.

At operation 2420, the first STA determines a TXOP compensation length based on a length of the trigger frame, a length of the low latency data frame, and a length of a second BA frame wirelessly transmitted by the AP to the other STA that acknowledges the low latency data frame. The second BA frame may be a standard BA frame, an enhanced BA frame, or a multi-BA frame.

At operation 2425, the first STA extends the TXOP of the first STA by the TXOP compensation length. In an embodiment, operation 2425 may involve operations 2430-2440. At operation 2430, the first STA wirelessly transmits a CTS to self frame. At operation 2435, the first STA wirelessly transmits a data frame to the AP after wirelessly transmitting the CTS to self frame. At operation 2440, the first STA wirelessly receives an ACK frame that acknowledges the data frame from the AP after wirelessly transmitting the data frame.

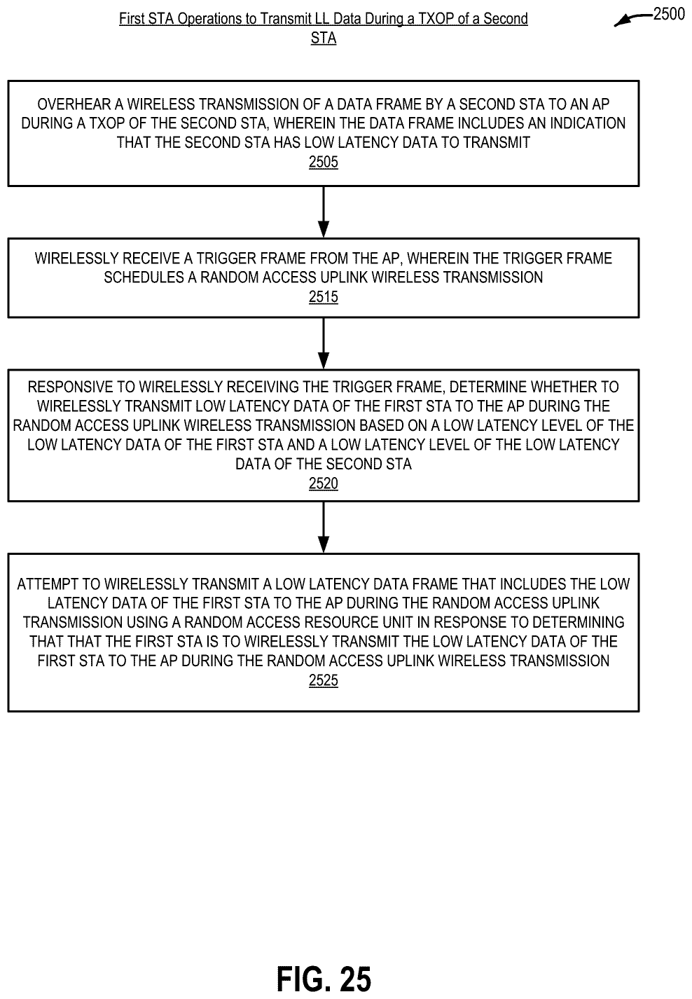

Turning now to FIG. 25, a method 2500 performed by a first STA will be described for transmitting low latency data during a TXOP of a second STA, in accordance with an example embodiment. The first STA may be implemented by a wireless device.

At operation 2505, the first STA overhears a wireless transmission of a data frame by a second STA to an AP during a TXOP of the second STA, wherein the data frame includes an indication that the second STA has low latency data to transmit.

At operation 2510, the first STA wirelessly receives a trigger frame from the AP, wherein the trigger frame schedules a random access uplink wireless transmission.

At operation 2515, responsive to receiving the trigger frame, the first STA determines whether to wirelessly transmit low latency data of the first STA to the AP during the random access uplink wireless transmission based on a low latency level of the low latency data of the first STA and a low latency level of the low latency data of the second STA.

At operation 2520, the first STA attempts to wirelessly transmit a low latency data frame that includes the low latency data of the first STA to the AP during the random access uplink wireless transmission using a random access resource unit in response to determining that the first STA is to wirelessly transmit the low latency data of the first STA to the AP during the random access uplink wireless transmission.

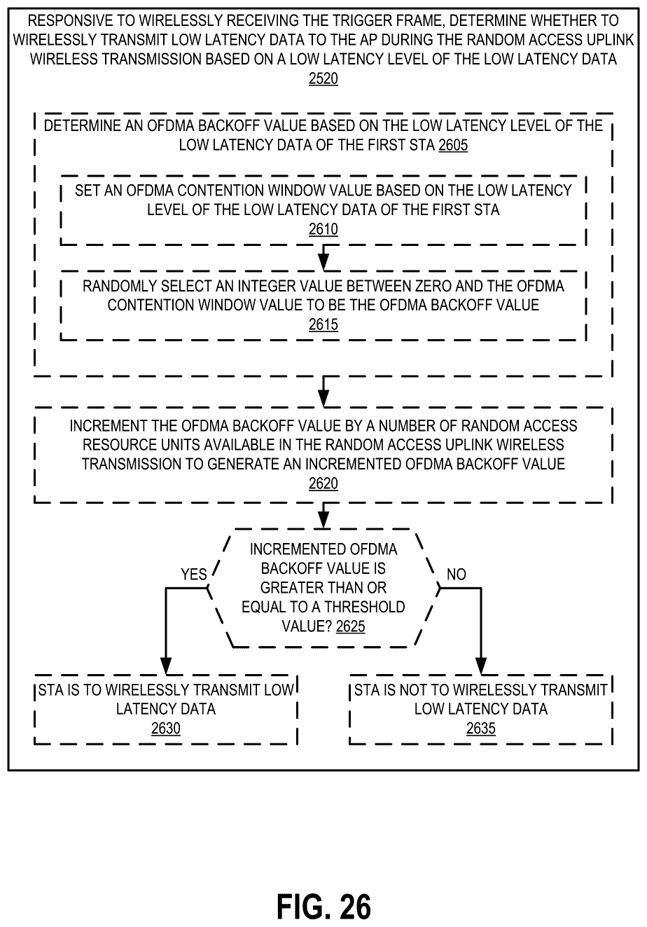

Turning now to FIG. 26, a method 2600 performed by a first STA will be described for determining whether to wirelessly transmit low latency data to the AP during the random access uplink wireless transmission, in accordance with an example embodiment. The first STA may be implemented by a wireless device.

The method may be one way to perform operation 2520 (determining whether to wirelessly transmit the low latency data of the first STA to the AP during the random access uplink wireless transmission).

At operation 2605, the first STA determines an OFDMA backoff value (also referred to as an OBO value herein) based on the low latency level of the low latency data of the first STA. Operation 2605 may involve operations 2610 and 2615. At operation 2610, the first STA sets an OFDMA contention window value based on the low latency level of the low latency data of the first STA. At operation 2615, the first STA randomly selects an integer value between zero and the OFDMA contention window value to be the OFDMA backoff value.

At operation 2620, the first STA increments the OFDMA backoff value by a number of random access resource units available in the random access uplink wireless transmission to generate an incremented OFDMA backoff value.

At operation 2625, the first STA determines whether the incremented OFDMA backoff value is greater than or equal to a threshold value. If the incremented OFDMA backoff value is greater than or equal to the threshold value, the first STA determines at operation 2630 that it is to wirelessly transmit low latency data. Otherwise, if the incremented OFDMA backoff value is not greater than or equal to the threshold value, the first STA determines at operation 2635 that it is not to wirelessly transmit low latency data.

In an embodiment, responsive to determining that a previous attempt to wirelessly transmit the low latency data frame during the random access uplink wireless transmission failed, the first STA increments a previous OFDMA contention window value to generate an incremented OFDMA contention window value. The first STA may then randomly select an integer value between zero and the incremented OFDMA contention window value to be the OFDMA backoff value. The first STA may then determine whether to wirelessly transmit low latency data during an upcoming random access uplink wireless transmission based on the selected value.

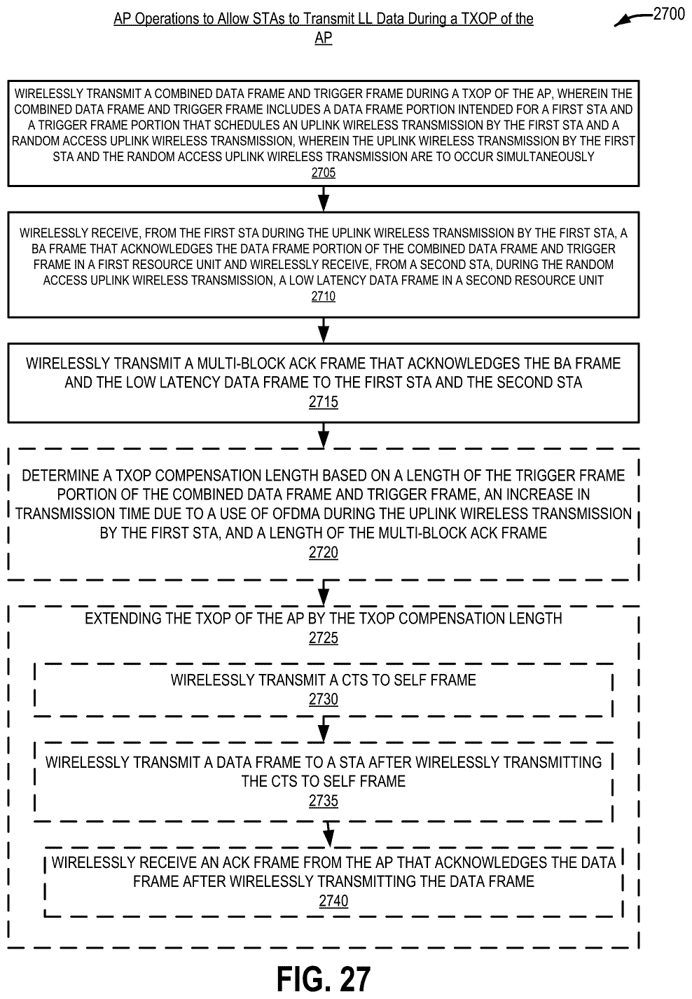

Turning now to FIG. 27, a method 2700 performed by an AP will be described for allowing STAs to transmit low latency data during a TXOP of the AP, in accordance with an example embodiment. The AP may be implemented by a wireless device.

At operation 2705, the AP wirelessly transmits a combined data frame and trigger frame during a TXOP of the AP, wherein the combined data frame and trigger frame includes a data frame portion intended for a first STA and a trigger frame portion that schedules an uplink wireless transmission by the first STA and a random access uplink wireless transmission, wherein the uplink wireless transmission by the first STA and the random access uplink wireless transmission are to occur simultaneously.

At operation 2710, the AP wirelessly receives, from the first STA during the uplink wireless transmission by the first STA, a BA frame that acknowledges the data frame portion of the combined data frame and trigger frame in a first resource unit and wirelessly receives, from a second STA during the random access uplink wireless transmission, a low latency data frame in a second resource unit. The BA frame may be a standard BA frame, an enhanced BA frame, or a multi-BA frame.

At operation 2715, the AP wirelessly transmits a multi-block ACK frame that acknowledges the BA frame and the low latency data frame to the first STA and the second STA. In an embodiment, the multi-block ACK frame is a combined data and multi-block ACK frame that includes a second data frame portion intended for the first STA.

In an embodiment, at operation 2720, the AP determines a TXOP compensation length based on a length of the trigger frame portion of the combined data frame and trigger frame, an increase in transmission time due to a use of OFDMA during the uplink wireless transmission by the first STA, and a length of the multi-block ACK frame.

In an embodiment, at operation 2725, the AP extends the TXOP of the AP by the TXOP compensation length. In an embodiment, operation 2725 involves operations 2730-2740. At operation 2730, the AP wirelessly transmits a CTS to self frame. At operation 2735, the AP wirelessly transmits a data frame to a STA after wirelessly transmitting the CTS to self frame. At operation 2740, the first STA wirelessly receives an ACK frame that acknowledges the data frame from the STA after wirelessly transmitting the data frame.

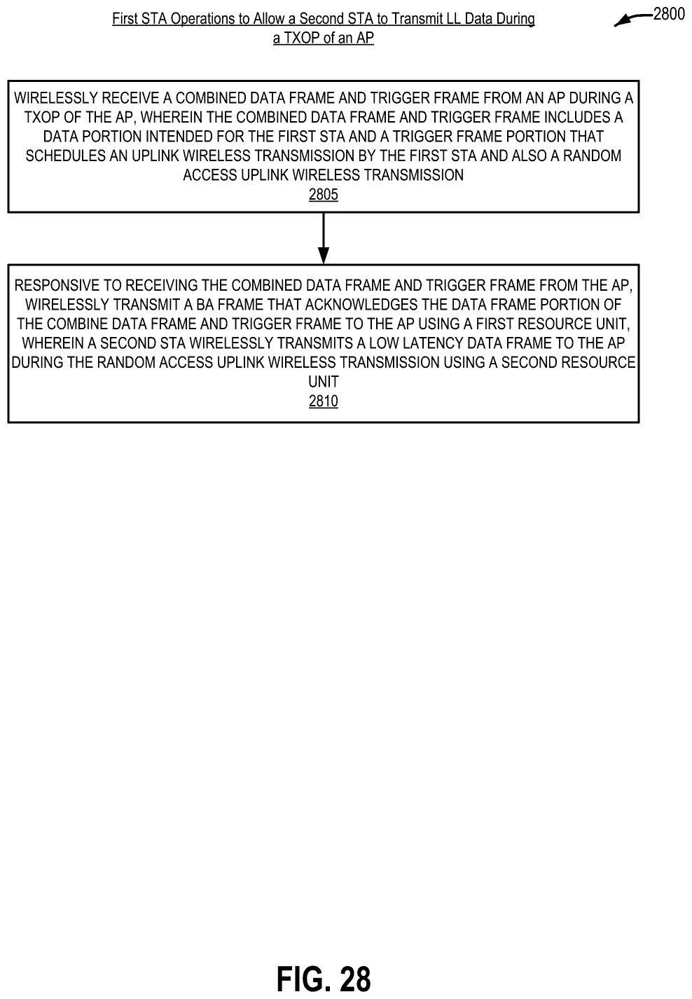

Turning now to FIG. 28, a method 2800 performed by a first STA will be described for allowing a second STA to transmit low latency data during a TXOP of the AP, in accordance with an example embodiment. The first STA may be implemented by a wireless device.

At operation 2805, the first STA wirelessly receives a combined data frame and trigger frame from the AP during a TXOP of the AP, wherein the combined data frame and trigger frame includes a data frame portion intended for the first STA and a trigger frame portion that schedules an uplink wireless transmission by the first STA and also a random access uplink wireless transmission.

At operation 2810, responsive to receiving the combined data frame and trigger frame from the AP, the first STA wirelessly transmits a BA frame that acknowledges the data frame portion of the combined data frame and trigger frame to the AP using a first resource unit, wherein a second STA wirelessly transmits a low latency data frame to the AP during the random access uplink wireless transmission using a second resource unit. The BA frame may be a standard BA frame, an enhanced BA frame, or a multi-BA frame. In an embodiment, the BA frame includes an indication that the first STA has low latency data to transmit so the AP should hold its transmission.

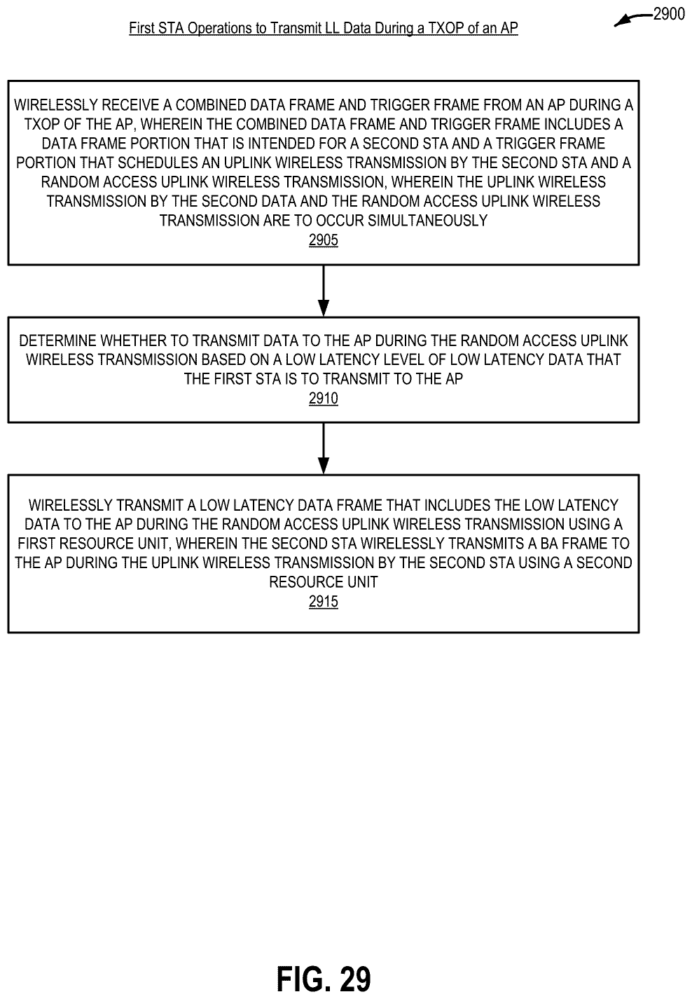

Turning now to FIG. 29, a method 2900 performed by a first STA will be described for transmitting low latency data during a TXOP of the AP, in accordance with an example embodiment. The first STA may be implemented by a wireless device.

At operation 2905, the first STA wirelessly receives a combined data frame and trigger frame from the AP during a TXOP of the AP, wherein the combined data frame and trigger frame includes a data frame portion that is intended for a second STA and a trigger frame portion that schedules an uplink wireless transmission by the second STA and a random access uplink wireless transmission, wherein the uplink wireless transmission by the second STA and the random access uplink wireless transmission are to occur simultaneously.

At operation 2910, the first STA determines whether to transmit data to the AP during the random access uplink wireless transmission based on a low latency level of low latency data that the first STA is to transmit to the AP.

At operation 2915, the first STA wirelessly transmits a low latency data frame that includes the low latency data to the AP during the random access uplink wireless transmission using a first resource unit, wherein the second STA wirelessly transmits a BA frame to the AP during the uplink wireless transmission by the second STA using a second resource unit. The BA frame may be a standard BA frame, an enhanced BA frame, or a multi-BA frame.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method performed by a wireless device functioning as an access point (AP) in a wireless network to transmit low latency data, the method comprising:
wirelessly receiving a data frame from a first station (STA) during a transmission opportunity (TXOP) of the first STA;
responsive to determining that the AP has low latency data to transmit, wirelessly transmitting a block acknowledgement (BA) frame that acknowledges the data frame to the first STA, wherein the BA frame includes an indication that the AP has low latency data to transmit so the first STA should hold its transmission; and
wirelessly transmitting a low latency data frame to a second STA following the transmission of the BA frame.

2. The method of claim 1, wherein the low latency data frame is transmitted after a first interframe space interval following the transmission of the BA frame, wherein the first interframe space interval is shorter than a second interframe space interval that is to be used by the first STA following the transmission of the BA frame.

3. The method of claim 2, wherein the indication that the AP has low latency data to transmit being included in the BA frame causes the first STA to use the second interframe space interval when attempting to access a wireless channel.

4. The method of claim 3, wherein the first interframe space interval is a short interframe space (SIFS) interval and the second interframe space interval is a point coordination function interframe space (PIFS) interval or a distributed coordination function interframe space (DIFS) interval.

5. The method of claim 2, further comprising:
wirelessly receiving a data frame from the first STA after the second interframe space interval following the transmission of the BA frame due to a transmission failure of the low latency data frame.

6. The method of claim 1, wherein the indication that the AP has low latency data to transmit is included in a field of a preamble of the BA frame.

7. The method of claim 6, wherein the field of the preamble is a universal signal (U-SIG) field.

8. The method of claim 6, wherein the field of the preamble is an ultra high reliability signal (UHR-SIG) field.

9. The method of claim 1, wherein the indication that the AP has low latency data to transmit is included in a field of a media access control (MAC) protocol data unit (PDU) of the BA frame.

10. The method of claim 9, wherein the field is included in a BA control field of the BA frame.

11. The method of claim 1, wherein the indication that the AP has low latency data to transmit comprises four bits.

12. The method of claim 11, wherein three of the four bits is used for indicating a low latency level of low latency data and a remaining one of the four bits is use for indicating whether the low latency level is for low latency data included in a current frame or a future frame.

13. The method of claim 1, further comprising:
wirelessly receiving a second BA frame that acknowledges the low latency data frame from the second STA.

14. The method of claim 1, wherein the second STA is the same as the first STA.

15. A method performed by a wireless device functioning as a first station (STA) in a wireless network to allow an access point (AP) to transmit low latency data, the method comprising:
wirelessly transmitting a data frame to the AP during a transmission opportunity (TXOP) of the first STA;
wirelessly receiving a block acknowledgement (BA) frame that acknowledges the data frame from the AP; and
responsive to determining that the BA frame includes an indication that the AP has low latency data to transmit, using a second interframe space interval instead of a first interframe space interval when attempting to access a wireless channel, wherein the second interframe space interval is longer than the first interframe space interval.

16. The method of claim 15, further comprising:
determining a TXOP compensation length based on a length of the low latency data frame and a length of the BA frame; and
extending the TXOP of the first STA by the TXOP compensation length.

17. The method of claim 16, wherein extending the TXOP of the first STA by the TXOP compensation length comprises:
wirelessly transmitting a clear-to-send (CTS) to self frame;
wirelessly transmitting a data frame to the AP after wirelessly transmitting the CTS to self frame; and
wirelessly receiving an acknowledgement (ACK) frame that acknowledges the data frame from the AP after wirelessly transmitting the data frame.

18. The method of claim 16, wherein the length of the low latency data frame is determined based on a legacy signal (L-SIG) field or a universal signal (U-SIG) field of a preamble of the low latency data frame, and wherein the length of the BA frame is determined based on a L-SIG field or a U-SIG field of a preamble of the BA frame.

19.-29. (canceled)
